(19) United States
(12) Patent Application Publication
(10) Pub. No.: US 2007/0058661 A1
(43) Pub. Date: Mar. 15, 2007

(54) Media access control architecture

(75) Inventor: Peter E. Chow, Orlando, FL (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Optimal Licensing Corporation, Freeport (BS)

(21) Appl. No.: 11/512,742

(22) Filed: Aug. 30, 2006

Related U.S. Application Data
(60) Provisional application No. 60/713,052, filed on Sep. 1, 2005.

(51) Int. Cl. H04L 12/413

(52) U.S. Cl. 370/445; 370/338

(57) ABSTRACT

Systems and methods which provide a scheduled media access control (MAC) architecture are shown. Scheduled MAC architectures provided according to embodiments result in a one function-at-a-time approach, wherein stations are provided parallel process media access. A communication framework is established for communication among stations, wherein the communication framework preferably defines how to request to access, how to send data frames, and/or how to terminate a session in terms of functional intervals. The functional intervals are preferably arranged in such a manner that the fairness, throughput efficiency, contention, traffic flow management, and latency are considered. A super frame structure is preferably defined from the various functional intervals. The scheduled MAC architecture could co-exist with other MAC protocols such as those based on carrier sensor multiple access schemes.

### CROSS-REFERENCE TO RELATED APPLICATIONS

The present application claims priority to U.S. provisional application Ser. No. 60/713,052 entitled “A Multiple Access Control Architecture,” filed Sep. 1, 2005, the disclosure of which is incorporated herein by reference.

### TECHNICAL FIELD

The invention relates generally to communications and, more particularly, to providing media access control with respect to shared communication media.

### BACKGROUND OF THE INVENTION

Connection based (e.g., switched link) and connectionless based (e.g., packet routed) communication techniques have been long defined in Comite Consultatif International Telephonique et Telegraphique (CCITT) and International Telecommunication Union (ITU) telecommunication standards. In connection based communications, the complete set of transmissions between communicating stations will use the same communication path (e.g., a switched link). Connection based communications is how the public switched telephone network (PSTN) has traditionally operated in the past. For an example, when a call is connected, the end to end connection is maintained during the entire time of the call and all transmissions between the stations are communicated through that connection. In contrast to connection based communications, in connectionless based communications each transmission between communicating stations may pass through different paths within a network or networks (e.g., packets are each individually routed via a then “best” path through the network from endpoint to endpoint). Typically, data networks, such as the public data network (Internet), local area networks (LANs), metropolitan area networks (MANs), wide area networks (WANs), etcetera, are based on a connectionless architecture.

When a communication medium (e.g., copper transmission line, power line, air, optical fiber, etcetera) is shared by a plurality of stations, such as in a connectionless architecture, some form of media access control (MAC) is typically desirable in order to arbitrate their use of the media and to facilitate shared use of the media. LANs, WANs, the Internet, etcetera are designed to serve multiple stations via a shared medium as shown in FIG. 1, and probably provide the most prevalent MAC schemes. Multiple access capability as provided by MAC is often considered essential for stations, such as user terminals 101-105, to communicate via a shared medium, e.g., medium 100 which may comprise copper transmission line, power line, air, optical fiber, etcetera, with an access point, router, switch, gateway, base station, etcetera, represented in FIG. 1 as gateway 111, depending on which system is referred to.

Normally, the MAC and physical layer specification are always closely coupled, and therefore issued as a single specification document. The result has been that there are many different MAC schemes in use (e.g., Ethernet for wireline, IEEE 802.11 (WiFi) for wireless, power line communication systems for power line, etcetera) because of differences in media physical characteristic.

Although there are many different MAC schemes which have been implemented, there are some commonalities in the approaches to MAC layer design. Various MAC schemes implemented by different manufacturers for a variety of media often implement either a collision avoidance scheme or a collision detection scheme. Examples of such MAC schemes may be found in TIA/IS-94 (TDMA cellular specifications), TIA/EIA 95-B (CDMA cellular specifications), TIA/EIA/IS-2000 series (CDMA2000 cellular specifications), TIA/EIA-732 series (Cellular data packet data specification), IEEE 802.3-2002 (carrier sense multiple access with collision detection (CSMA/CD) access method and physical layer specifications), and IEEE 802.11 (wireless LAN medium access control (MAC) and Physical Layer (PHY) Specifications), which are incorporated herein by reference. These MAC schemes are generally not compatible with one another, requiring arbitration there between (e.g., a bridge or gateway between networks employing different ones of the MAC schemes), and each utilize their own hardware and software configurations.

Many such MAC schemes (e.g., IEEE 802.11) implement a “one station-at-a-time” or serial process to provide collision avoidance and thus arbitrate access to the shared media. Other MAC schemes (e.g., Ethernet, such as IEEE 802.3) implement a random access process in which collision detection and back-off periods are provided to arbitrate access to the shared media. As will be better appreciated from the discussion which follows, each of these schemes has disadvantages associated therewith.

In order to provide an acceptable solution, MAC schemes typically need to address various issues in addition to arbitrating access to the shared media. Such other issues include performance objectives such as access fairness, contention control, throughput efficiency, network stability, and latency. Accordingly, MAC layer design performance characteristics generally include a balance between such performance objectives. Throughput and latency are commonly traded down for various other performance objectives. In general, throughput efficiency has lower priority in the foregoing balance because equipment suppliers state the raw transmission rate (not throughput rate) and, in typical user traffic requirements, the media is not the bottleneck.

To better aid in the understanding of current MAC schemes, details with respect to two widely used data network MAC schemes are provided below. Specifically, the IEEE 802.11 (WiFi) MAC scheme, providing an example of a collision avoidance scheme, and the Ethernet MAC scheme, providing an example of a collision detection scheme, are discussed below.

IEEE 802.11 provides for two MAC configurations: One is a point coordination function (PCF), often referred to as the “infrastructure” configuration; and the other is a distributed coordination function (DCF), often referred to as the “ad-hoc” or peer to peer configuration. PCF controls the media for access point communication with stations, while DCF provides control of the media for individual station communications.

PCF operation (e.g., “infrastructure” configuration) is based on point coordination having total control of the media all the time, and thus provides a collision avoidance scheme. The method of communicating with stations comprises polling one station-at-a-time as shown in FIG. 2. Each repetition interval (e.g., repetition interval 200) is started with a beacon frame (e.g., beacon frame 201) which informs the stations of the start of a new repetition and broadcasts control messages. Next, a polling frame (e.g., polling frame 202) is sent for the first station. This polling frame may include data, if any, for the first station. The first station responds with an “ACK” frame (e.g., ACK frame 203). The ACK frame may include data, if any, from the first station. PCF operation continues to poll other stations one at a time using polling frames associated with each such station (e.g., polling frames 204, 206, and 207). The stations respond to the polling frames with ACK frames (e.g., ACK frames 205 and 208) as described above, it being appreciated that a station may not respond with an ACK frame in certain situations, such as where the station has been powered down or has gone to sleep.

As can be seen in FIG. 2, the shortest interframe space (SIFS) and PFC interframe space (PIFS) are provided between ones of the aforementioned frames to provide time spacing. For example, SIFS is used for time spacing between frames, such as to accommodate propagation delays. PIFS is used for time spacing from one end of a polling frame to the start of next polling frame when the polled station did not response.

The upper bound for throughput of a PCF MAC layer is the case represented in repetition interval 310 of FIG. 3, comprising a stream of repetition of poll frame, SIFS, and ACK with data frame. Assuming the poll frame, SIFS, and ACK with data frame are typically about 62 bytes, 10 μs, and 500 bytes respectively, the upper bound throughput efficiency is from 89% to 16% with raw bit rates of 1 Mb/s to 1 Gb/s, respectively. Another upper bound of interest is for single station throughput. Assuming a 5-station model in which one station in the model is active all time and the other four are idle (see repetition interval 320 of FIG. 3), the upper bound for single station throughput efficiency is 50% to 4% with raw bit rates of 1 Mb/s to 1 Gb/s, respectively. Table 330 of FIG. 3 shows the upper bound throughput versus raw bit rate (the bit rate in media).

The main advantage of the foregoing PFC scheme is that the system operates in a contention free environment. However, there are a number of drawbacks associated with the scheme, including spending time on stations that have no data to send or are inactive, substantial non-active time (e.g., SIFSs and PIFSs), and variable delay. PCF performance characteristics are as follows: (1) Contention, no contention, which simplifies the system operation and throughput; (2) Fairness, high degree of fairness, wherein all stations have the equal chance to access the media; (3) Latency, latency changes with traffic load; and (4) Throughput, throughput efficiency is low.

DCF operation (e.g., “ad-hoc” or peer to peer configuration) is based on a collision avoidance to provide control of the media without point coordination. Specifically, DCF as implemented by IEEE 802.11 utilizes carrier sense multiple access (CSMA), collision avoidance (CA) (CSMA/CA), with request to send (RTS) and clear to send (CTS). A major difference between the DCF scheme of IEEE 802.11 and Ethernet is the DCF capability of handling hidden nodes. Hidden node means that one or more stations in the network could not detect some other stations' transmission status and thus such other stations are “hidden” (a hidden node) with respect to that station. In wireless and power line communication networks, hidden nodes are common due to high path loss between some stations. CSMA/CA with RTS/CTS was developed to address the hidden node problem.

An example single connection process of CSMA/CA with RTS/CTS is shown in FIG. 4. The source could be a station which sent a RTS (e.g., RTS 401) after the media has remained idle for a time equal to the distributed interframe space (DIFS). This RTS acts not only as a request to send, but also as a network allocation vector (NAV) to all other stations except the destination. When a station detects the NAV (here the RTS), it means medium is busy for next two data frames. The destination, e.g., an access point, may respond to the RTS with a CTS (e.g., CTS 402) after a SIFS interval. The original source detects the CTS, interprets it as “media is clear” and “destination is ready to receive massages” and thus transmits its data (e.g., data 403) after a SIFS interval. The CTS, like the RTS, acts not only as a handshaking packet between stations, but also as a NAV to other stations, indicating that the medium will be free after one data frame. The destination provides an ACK (e.g., ACK 404) in response to the data, after a SIFS interval, to inform the source that the transmission was successful. In order to establish fairness with respect to medium access, the source (which just utilized the medium to transmit the data) invokes a contention window (e.g., contention window 405) to stop it from contending for media access in the next frame.

FIG. 5 shows an example of CSMA/CA operation in a multiple station environment. In the example of FIG. 5, station A completes transmission of frame 501, such as may correspond to RTS 401, CTS 402, data 403, and ACK 404 described above, and invokes contention window 502, such as may correspond to contention window 405 described above, for fairness. Each of stations B-D of the illustrated embodiments began a media access process during frame 501, but through use of the aforementioned NAVs deferred their access until the end of frame 501 plus the duration of the DIFS period (shown as point 503 in the timeline of FIG. 5). Upon the completion of the frame, each of stations B-D detects that the medium is free, and waits at least the duration of the DIFS period to access the medium (e.g., transmit a RTS). However, in order to avoid media contention or communication collisions, CSMA/CA of the illustrated example includes a random access time or back off period added to the access deferral time for each station, shown here as back off periods 504, 505, and 506 for stations B, C, and D respectively. If the media remains free at the conclusion of a station's back off period, the station may then transmit a RTS.

In the illustrated example, station C has the shortest back off period and thus accesses the medium to complete transmission of frame 507, such as may correspond to RTS 401, CTS 402, data 403, and ACK 404 described above, and invokes contention window 508, such as may correspond to contention window 405 described above, for fairness. As shown in the illustrated example, stations B and D complete their respective back off periods during frame 507, and thus find the media is busy. Stations B and D initiate a transmission deferral and random back off again as described above. Also, as shown in the illustrated example, station E began a media access process during frame 507, but found the medium busy and deferred access until the end of frame 507 plus the duration of the DIFS period (shown as point 509 in the timeline of FIG. 5) as previously described.

Upon the completion of frame 507 by station C, each of stations B-E detects that the medium is free, and waits at least the duration of the DIFS period and their respective back off periods to access the medium, as previously described. In the illustrated example, back off periods 510 (station B) and 512 (station E) are longer than back off period 511 (station D), and thus station D finds the medium free and thus accesses the medium to complete transmission of frame 513.

In an effort to provide fairness, the back off period for station B is shortened at back off period 510 (as compared to back off period 504), because station B has waited once for the medium. However, because the randomly selected back off period for station E (back off period 512) was initially shorter than the corresponding back off period for station B (back off period 510), station E is able to secure the medium after the conclusion of frame 513 in the illustrated embodiment. That is, both stations B and E shortened their subsequent back off periods, but the resulting respective back off periods were such that station E was the first to access the medium.

It should be appreciated that the foregoing collision avoidance depends upon each station being able to detect the NAVs. Where there is a hidden node situation (i.e., one station is unable to detect transmissions from another station), the aforementioned NAVs, such as a RTS from a particular station, may not be detected by another station. Accordingly, the medium may be attempted to be used by more than one station simultaneously, causing the transmissions of each to be unusable. Such collisions may result in an appreciable decrease in throughput and the likelihood of such undetected collisions increases with the number of stations and with particular topologies.

The main advantage of the foregoing DCF scheme is that the system does not implement idle periods or polling periods with respect to inactive stations (e.g., stations which are powered down or have gone to sleep). However, there are a number of drawbacks associated with the scheme, including appreciable idle periods associated with contention control, substantial non-active time (e.g., SIFSs and DIFSs), and throughput being impacted by hidden nodes. DCF performance characteristics are as follows: (1) Contention, substantial contention, which results in complex system operation and decreased throughput; (2) Fairness, moderate degree of fairness, wherein randomization may result in some stations having increased chances to access the media; (3) Latency, latency changes with traffic load; and (4) Throughput, throughput efficiency is low.

From the above, it can be seen that fairness is not ensured through contention resolution using collision detection with back off periods and, although fairness can be achieved through point coordination contention resolution, throughput often suffers as a result of point coordination providing collision avoidance contention resolution. Moreover, periods of media non-use, such as the aforementioned SIFSs, DIFSs, and back off periods, impact throughput.

### BRIEF SUMMARY OF THE INVENTION

The present invention is directed to systems and methods which provides a scheduled media access control (MAC) architecture. Stations are preferably synchronized for communication using a scheduled MAC of embodiments of the present invention. Scheduled MAC provided according to embodiments of the invention not only provides contention control through a collision avoidance architecture, but also provides access fairness, whether equal access or unequal access (e.g., quality of service (QoS) based access, weighted advantage access, priority access, etcetera), contention control.

Embodiments of the invention decouple the MAC layer from the physical layer through implementation of a scheduled MAC which is media independent. Accordingly, MAC architectures of embodiments are independent of the physical layer, whether it is duplex or simplex, time division multiple access (TDMA), channelized division multiple access (e.g., frequency division multiple access (FDMA), code division multiple access (CDMA), etcetera), and/or the like. Embodiments of the present invention may be utilized in providing media access control with respect to a variety of media. For example, embodiments of the invention may provide a MAC architecture utilized with respect to wireless, power line, and/or wireline infrastructure. Similarly, different MAC architectures, perhaps optimized with respect to different performance criteria, may be provided for use with one physical layer (e.g., a common hardware platform) according to embodiments of the present invention.

Scheduled MAC architectures provided according to embodiments of the invention results in a one function-at-a-time approach, wherein stations are provided parallel process media access. For example, each station with a need to access the media conducts a request for media access prior to each such station conducting data transmission, thereby operating in a parallel process approach.

In accordance with an embodiment of the invention, a communication framework is established for communication among stations, such as among a station hosting point coordination (PC), gateways, bridges, user terminals, and other stations, over a shared medium. The communication framework preferably defines how to request to access, how to send data frames, and how to terminate a session in terms of functional intervals. The functional intervals are preferably arranged in such a manner that the fairness, throughput efficiency, contention, traffic flow management, and latency are considered. Accordingly, a scheduled MAC architecture of embodiments of the invention is provided through selection of functions to be supported using the architecture, and optimizing the time sequence of the functions and the intervals for each function to meet the desired performance objectives, such as contention control, access fairness, throughput efficiency, network stability, and latency. The function-at-a-time approach implemented according to embodiments of the invention simplifies processes used to manage the functional intervals.

Scheduled MAC architectures implemented according to embodiments of the invention provide the capability of serving both connection and connectionless communications in one single sheared media. For example, connectionless based communications may be served through stations having a need for media access to issue an ad hoc request for a next data frame functional interval during a need for access functional interval, whereas connection based communications may be served through stations scheduling or reserving media access during a series of data frame functional interval during a need for access functional interval.

In operation according to an embodiment of the invention, point coordination, such as may be implemented (hosted) in a gateway, bridge, access point, or other node or station in communication with a shared medium, provides a beacon indicating the start of a scheduled MAC super frame. Each station needing access to the medium may respond with an acknowledgement (ACK) or other indication of there being a need for access in a need for access (NFA) functional interval. Additionally or alternatively, each station needing access to the medium may provide information with respect to the resources needed (e.g., the amount of bandwidth desired, a priority indicator, a scheduled access duration, etcetera), such as in the acknowledgement itself or another communication (e.g., within a request for resources (RFR) functional interval). Point coordination preferably provides information with respect to allocation of resources, such as when to transmit data in a data frame functional interval and the amount of data transmission bandwidth allocated to each station, in a when to send (WTS) functional interval. The stations may utilize this information to transmit data in a proper time slot within a data frame functional interval.

Data transmitted to the stations may be provided in one of the aforementioned functional intervals, such as the when to send functional interval, in a separate data frame functional interval for downlink transmission, etcetera. Information provided to the stations from point coordination, such as in the when to send functional interval, may identify uplink data transmission and/or downlink data functional interval transmission time slots for use by particular stations.

Super frames and the various functional intervals therein are preferably variable length to accommodate instantaneous traffic needs. For example, where no station requires media access, a super frame may be substantially shortened by the request for resources, when to send, and data transmission functional intervals having no data therein.

It should be appreciated that the above described functional intervals, as well as additional or alternative functional intervals, may be organized in super frames other than outlined above. For example, one or more associated functional intervals may be provided in different super frames. According to one embodiment, a need for access and request for resources functional interval are provided in a first super frame and an associated when to send and data frame functional intervals are provided in a subsequent super frame.

According to an embodiment of the invention, functional intervals may be utilized for functions other than functions of a scheduled MAC of the present invention. For example, a functional interval of a scheduled MAC superframe architecture may be reserved for existing MAC protocols. The co-existence with CSMA protocol, for example, my be supported by ensuring all other function intervals do not have any medium idle interval longer than DIFS, except the function interval is for CSMA protocol. In other words, scheduled MAC protocol devices will operate normally, until there is a blank interval where transmission from all scheduled MAC protocol devices is prohibited. The medium would then be free of the scheduled MAC protocol devices and the CSMA protocol device will become active because the medium is free.

Embodiments of the present invention implement optimization algorithms that take advantage of the aforementioned functional intervals to enhance MAC performance. Such optimization algorithms are preferably neutral in that, although it may optimize or improve one or more performance parameters, it has no negative impact with respect to the other performance parameters of interest. Using a communication framework having functional intervals according to embodiments of the invention, algorithms may operate to dynamically make allocation decisions based on full knowledge of the traffic status in order to optimize fairness, throughput efficiency, contention, traffic flow management, and latency using deterministic behavior of network characteristics. For example, information provided with respect to various stations' need for medium access (e.g., as may be provided in a request for resources) provided in a first functional interval may be utilized by such algorithms in allocating utilization of a following functional interval (e.g., allocating access to a data transmission frame to particular stations, allocating capacity within a data transmission frame to stations permitted to utilize the data transmission frame, etcetera).

Additionally or alternatively, such algorithms may dynamically adjust one or more of the functional intervals to optimize the throughput without degrading other performance objectives. According to one embodiment, the shortest interframe space (SIFS) is not a constant time interval, but rather a dynamically adjusted time slot interval determined using synchronized communications and calculated propagation delay information.

MAC architectures provided in accordance with concepts of the present invention provide contention resolution without back off processes, fairness without compromising throughput, reduced idle time (e.g., decreased SIFS, DIFS, etcetera), high throughput efficiency which is independent of the number of stations and the raw bit rate, and improved consistency with respect to latency. Moreover, MAC architectures of embodiments of the present invention provide deterministic performance with respect to network behavior under different conditions, which simplifies the development, testing and maintenance of the system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a network configuration providing communication via a shared medium;

FIG. 2 shows a prior art point coordination function providing media access control by polling one station at a time;

FIG. 3 shows the upper bound for throughput of a point coordination function a media access control layer of the prior art;

FIG. 4 shows a prior art distributed coordination function connection process providing carrier sense multiple access collision avoidance with request to send/clear to send;

FIG. 5 shows an example of prior art carrier sense multiple access collision avoidance operation in a multiple station environment;

FIG. 6 shows a network configuration providing communication via a shared medium adapted according to an embodiment of the present invention;

FIGS. 7A-7C show various configurations of a super frame defined by a scheduled media access control architecture of embodiments of the present invention;

FIG. 8 shows an embodiment of a scheduled media access control architecture of the present invention;

FIGS. 9A-9G show embodiments of frame structures of a scheduled media access control architecture of the present invention;

FIGS. 10A-10C show frame exchange protocols for providing various transactions according to embodiments of the present invention;

FIGS. 11A-11C show data frame exchange for data communication according to embodiments of the invention;

FIG. 12 shows an example of adaptation of Ethernet or WiFi stations to implement a scheduled media access control architecture of an embodiment of the present invention;

FIG. 13 shows an example of protocol adaptors are built around the media to make a scheduled media access control architecture transparent to standard network equipment according to an embodiment of the present invention;

FIG. 14 shows a scheduled media access control functional block diagram according to an embodiment of the present invention;

FIG. 15 shows a scheduled media access control access functional block diagram according to an embodiment of the present invention;

FIG. 16 shows a flow diagram of operation of a traffic flow control algorithm of an embodiment of the invention;

FIG. 17 illustrates interframe space versus location of observation point in the medium;

FIG. 18A illustrates a logical network, with locations of various stations and a gateway;

FIG. 18B shows a interframe space matrix of an embodiment of the present invention; and

FIG. 19 shows a flow diagram for detecting a minimum interframe space value and for implementing interframe space correction according to an embodiment of the present invention.

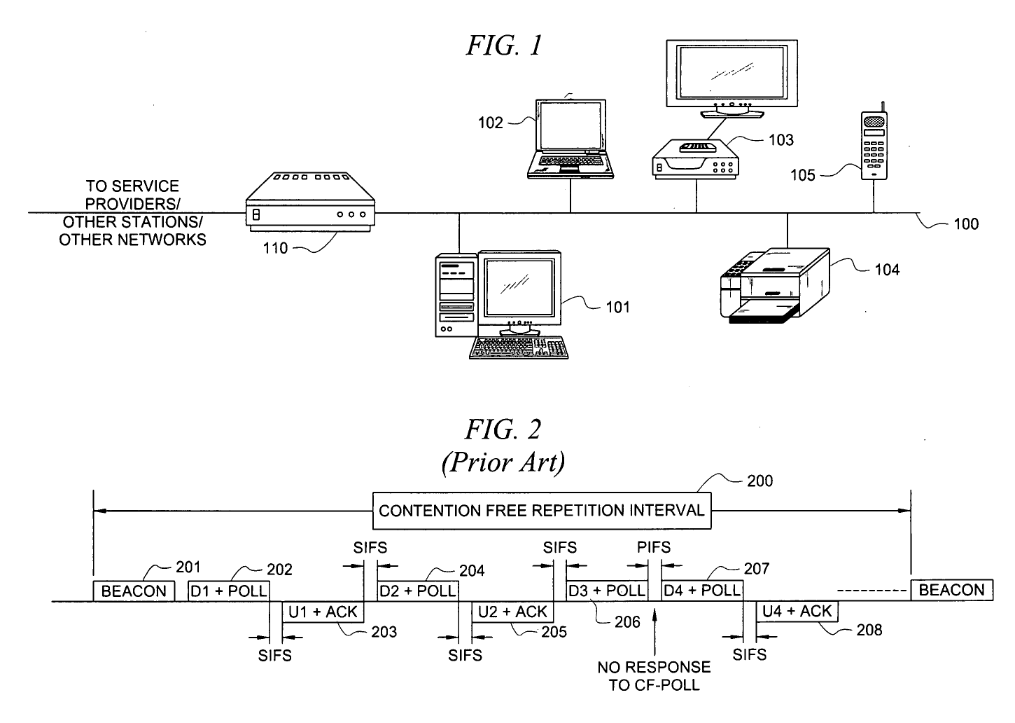

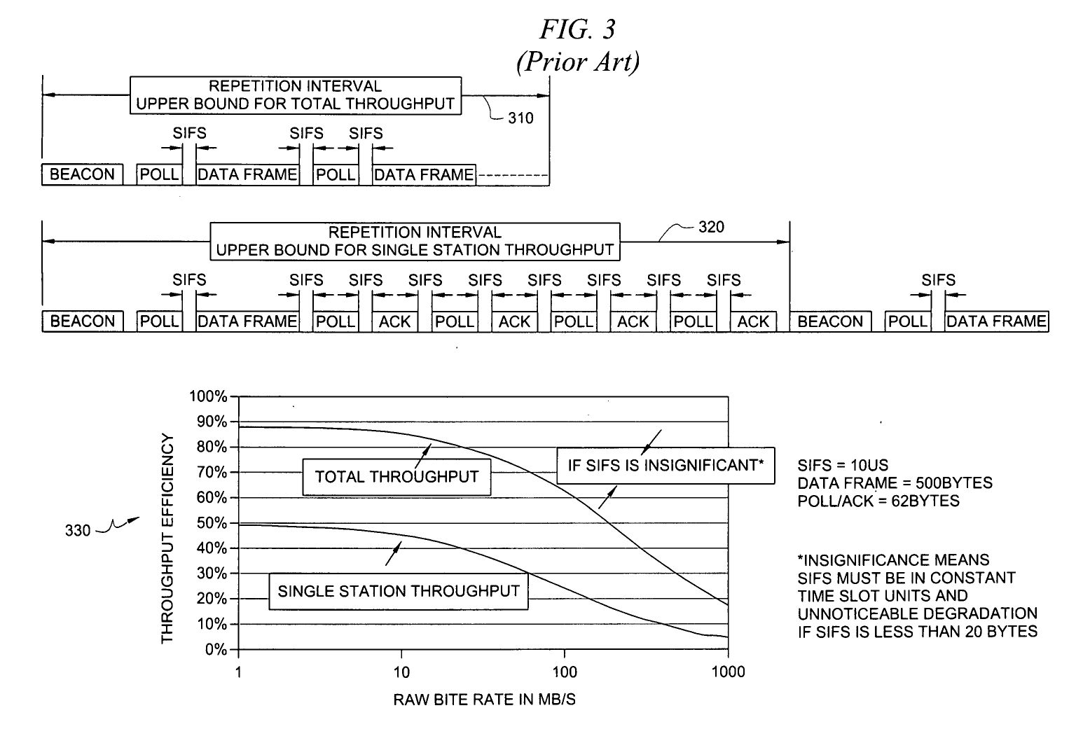

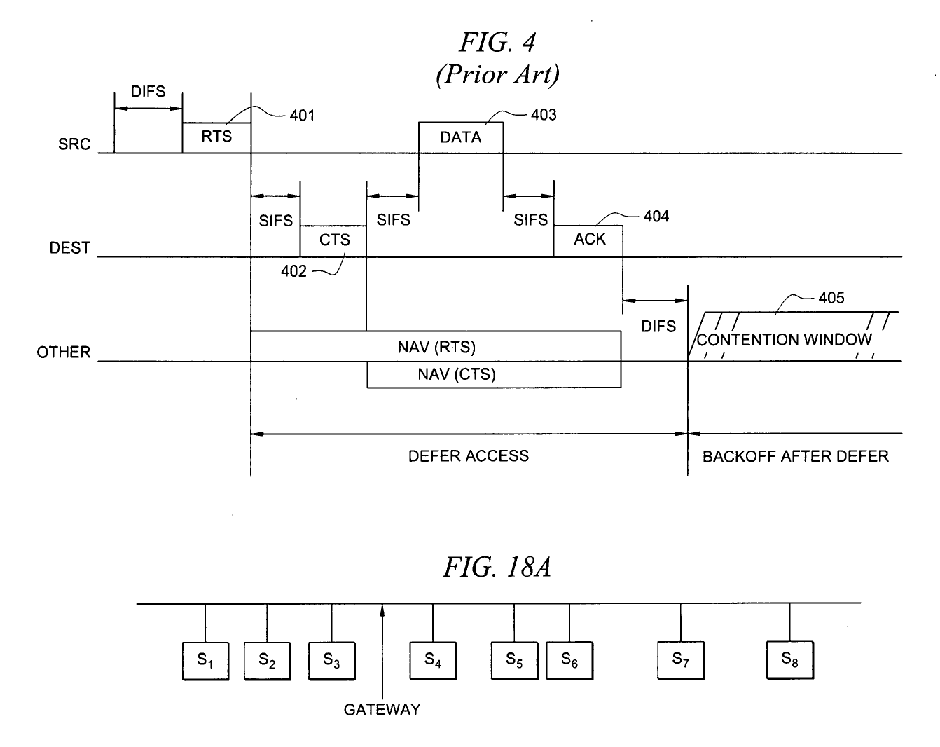

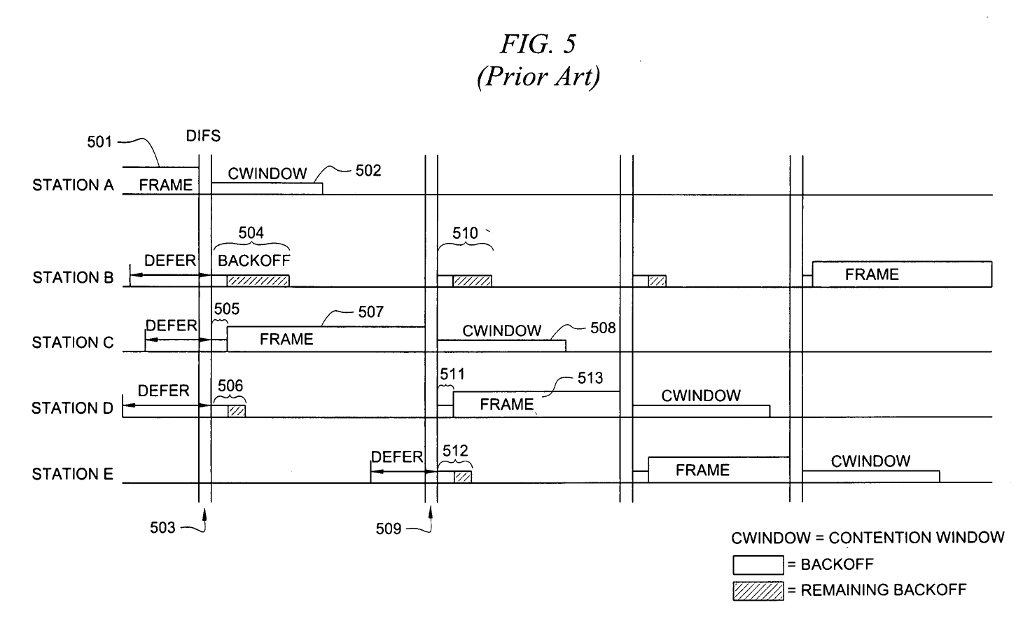

### DETAILED DESCRIPTION OF THE INVENTION

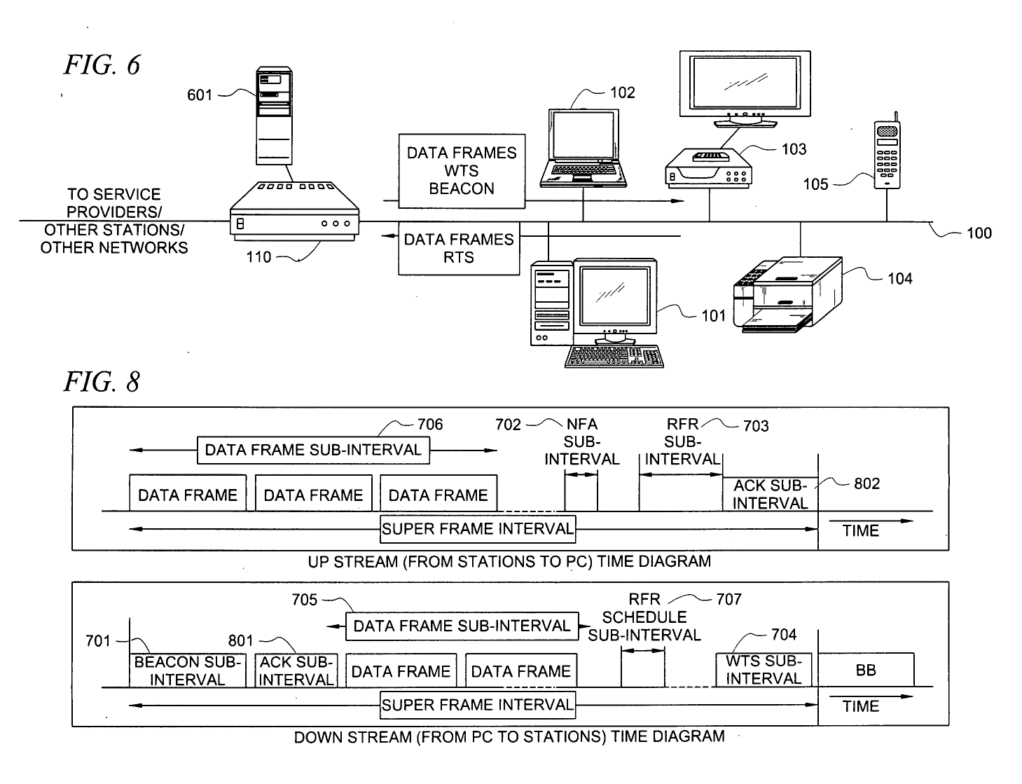

Media access control (MAC) platforms of embodiments of the invention establish the fundamental communication framework among point coordination (PC) (e.g., PC 601 of FIG. 6), gateways (e.g., gateway 110 of FIG. 6), bridges, stations (e.g., user terminals 101-105 of FIG. 6), and/or other devices for shared media (e.g., medium 100 of FIG. 6). Point coordination 601 of embodiments comprises control algorithms (e.g., software code) operable upon a host processor-based system (e.g., gateway 110, a bridge, a server, or other station) operable to provide media access control as described herein. In order to host point coordination 601 of embodiments, various stations such as gateway 110 may be adapted to include additional resources such as increased processing power, increased memory, added input/output functionality, etcetera. In order to respond to control provided according to point coordination 601, stations sharing media 100 (e.g., user terminals 102-105 and gateway 110) are adapted to include control algorithms implementing media access control as described herein. For example, media access control layer software algorithms may be provided to define operation at each of user terminals 101-105 as described herein.

Embodiments of the invention implement a scheduled media access control (MAC) architecture for providing contention control with respect to shared communication media. Scheduled MAC provided according to embodiments of the invention implements a functional interval framework for a variable length super frame resulting in a one function-at-a-time approach. MAC architectures of embodiments of the invention comprise MAC platform and optimization algorithm functional modules, wherein neutral algorithms are preferably operable with respect to multiple objective environments so that a neutral algorithm enhances one or more performance objectives without degrading other performance objectives.

Embodiments of the present invention may be utilized in providing media access control with respect to a variety of media and/or networks. For example, embodiments of the invention may provide a MAC architecture utilized with respect to wireless, power line, and/or wireline infrastructure. MAC architectures of embodiments of the invention may be utilized with respect to networks such as the public data network (Internet), local area networks (LANs), metropolitan area networks (MANs), wide area networks (WANs), the public switched telephone network (PSTN), cable transmission systems, satellite transmission systems, and/or the like.

The scheduled MAC architecture of embodiments of the invention partitions shared media communication bit stream(s) into repetitive super frame intervals. Each super frame interval preferably includes sub-intervals providing the aforementioned functional intervals. Point coordination (PC) of the MAC platform of embodiments provides a scheduler that manages the foregoing super frames and associated functional intervals by providing instruction to stations, such as gateway 110 or other host for the point coordination, user terminals 101-105, etcetera. Point coordination preferably manages the scheduling with full knowledge of the traffic requirements, thereby providing advantages over typical MAC schemes in achieving fairness, throughput efficiency, contention, traffic flow management, and/or latency.

With all upstream traffic being managed by point coordination of embodiments of the invention, the combination of point coordination and its host (e.g., a gateway) has the full knowledge of the network traffic. Accordingly, network traffic management and network performance (e.g., frame loss, overload conditions, etcetera) may be addressed in software.

Functional intervals of a super frame of embodiments include one or more data frame sub-intervals, a need for access (NFA) sub-interval, a request for resource (RFR) sub-interval, a acknowledge (ACK) sub-interval, a beacon sub-interval, and a when to send (WTS) sub-interval. The foregoing sub-intervals may be provided with respect to an upstream (e.g., terminal to gateway hosting point coordination) and/or downstream (e.g., gateway hosting point coordination to terminal) portion of the super frame. For example, the beacon sub-interval, WTS sub-interval, and/or a data frame sub-interval may be associated with a downstream portion of the super frame while the NFA sub-interval, RFR sub-interval, ACK sub-interval, and/or another data frame sub-interval may be associated with an upstream portion of the super frame.

In operation according to embodiments of the invention, control communications between point coordination and stations coordinating a scheduled MAC are via beacon sub-interval, NFA sub-interval, RFR sub-interval, WTS sub-interval, ACK sub-interval and control frames in the data frame sub-intervals. Payload data (e.g., network traffic carried between a gateway and associated terminals) is carried via data frame sub-intervals. The stations send data frames based on the scheduled slots defined by point coordination. One or more optimization algorithm of the point coordination preferably manipulates the functional intervals (e.g., order, length, assignment of resources to stations, etcetera) for optimum or desired performance.

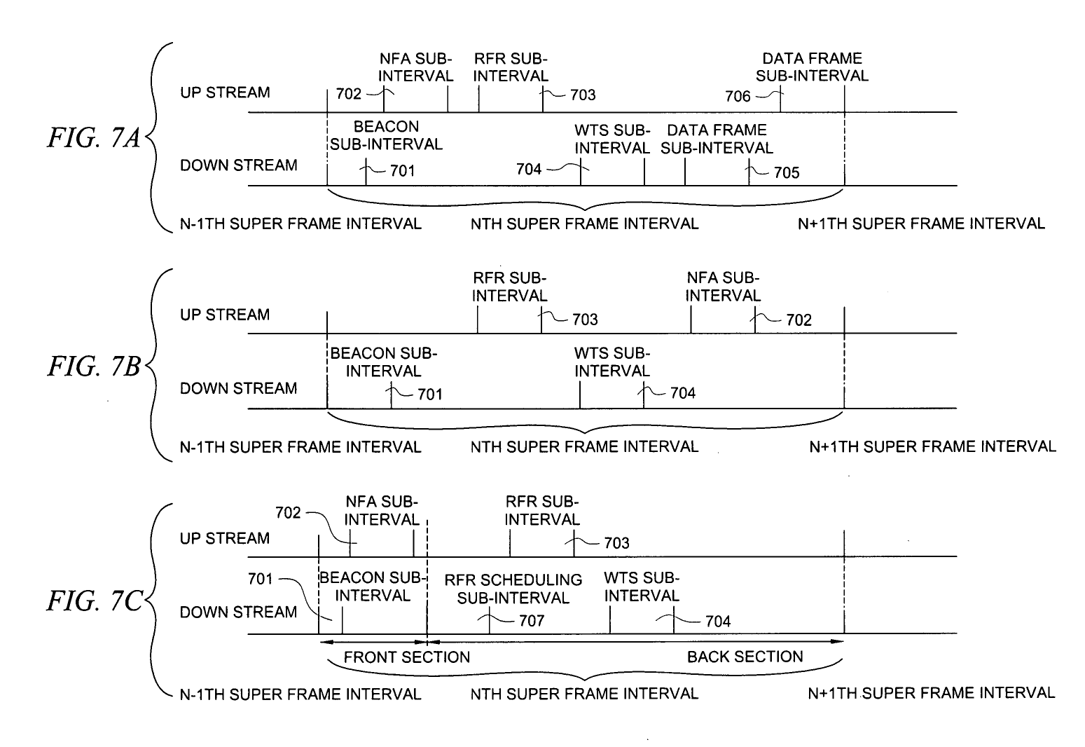

Directing attention to FIGS. 7A-7C, various configurations of a super frame defined by a scheduled MAC architecture of embodiments of the present invention are shown. The scheduled MAC architecture of the illustrated embodiments partitions the shared medium bit stream into repetitive super frame intervals, shown as N−1th super frame interval, Nth super frame interval, and N+1th super frame interval. Each super frame of the illustrated embodiment preferably includes a plurality of functional intervals defined therein, shown here as including beacon sub-interval 701, need for access (NFA) sub-interval 702, request for resources (RFR) sub-interval 703, when to sent (WTS) sub-interval 704, downstream data frame sub-interval 705, and upstream data frame sub-interval 706.

As will be better understood by the discussion which follows, the order and length of the functional intervals are variable according to embodiments of the invention. Accordingly, the embodiments of FIGS. 7A-7C illustrate several arrangements of functional intervals within super frames of scheduled MAC architectures of the present invention. The arrangements of functional intervals implemented according to embodiments of the invention may include spreading corresponding ones of the functional intervals across a plurality of super frame intervals. For example, a request for resources sub-interval may be provided in a different (e.g., immediately prior) super frame interval than a when to send sub-interval providing information in response to requests in the request for resources sub-interval.

It should be appreciated that not only may the data frame sub-intervals be positioned in a super frame differently than illustrated with respect to the other functional intervals (e.g., beacon sub-interval, NFA sub-interval, RFR sub-interval, and/or WTS sub-interval), the upstream and downstream data frame sub-intervals may be positioned differently than illustrated with respect to each other (e.g., upstream data frame sub-interval occurring in the super frame interval before the downstream data frame sub-interval). Because the placement of the data frame sub-intervals may be varied with respect to other functional intervals and other data frame sub-intervals, resulting in a very large number of possible configurations, the data frame sub-intervals have not been explicitly shown in FIGS. 7B and 7C, and are provided in but one configuration in FIG. 7A to simplify the drawings.

Although not expressly shown in the embodiments of FIGS. 7A-7C, acknowledgment (ACK) sub-intervals are utilized according to embodiments of the invention. For example, ACK sub-intervals may be disposed in the timeline of a super frame interval following another functional interval for which an acknowledgment of receipt by a receiving station is desired. As but one example, an ACK sub-interval may be defined in the upstream bit flow following downstream data frame sub-interval 705 in order to facilitate the stations having been assigned data frames in downstream data frame sub-interval 705 acknowledging receipt of their corresponding data frame.

The beginning of super frame intervals of embodiments of the invention are demarcated by a broadcast beacon, such as may be provided in beacon sub-interval 701 of the illustrated embodiments. Such a broadcast beacon may be utilized to synchronize the various stations sharing media, particularly in the case where the super frame intervals are variable length as in preferred embodiments of the present invention. Accordingly, the broadcast beacon of embodiments provides the time indication of the starting a new super frame. A broadcast beacon may be a unique data string or other transmission readily recognizable as a beacon by the stations. In addition to a beacon string, embodiments of the present invention may provide some amount of data (e.g., control data) within the beacon sub-interval. For example, sub-interval timing information, sub-interval length information, sub-interval organization information, timing offset (e.g., timing advance) information, functional interval time slot information (e.g., time slots for particular stations providing need for access and/or request for resources information in an appropriate sub-interval), and/or the like may be provided within a beacon sub-interval of embodiments of the invention.

In operation according to embodiments of the invention, a broadcast beacon provides various global messages for scheduled MAC implementation and control. Such global messages may comprise the time locations of each interval, e.g. super frame length, starting time of each interval in up and down stream, etcetera, to assist each station in locating intervals of interest. Where request for resources scheduling is used, as discussed below, the global message provided by the broadcast beacon may provide time locations of intervals in the front section of the super frame interval. Global messages provided by broadcast beacons of embodiments comprise traffic flow management information, such as loading status (e.g., light, medium and high), which allows traffic flow management algorithms implemented by the various stations to control access to the shared medium, such as to control need for access messaging. For example, if the loading status were medium, then stations that have sent data in a current super frame interval may be made ineligible to request data frames in a next super frame interval (e.g., the station provides a negative response in a need for access sub-interval although the station has a need for accessing the shared medium). Broadcast beacon global messages of embodiments may additionally or alternatively include maintenance messages, such as to turn off/on all station transmitters, to provide global software up-dates, etcetera. Add and/or remove station messages, for example, may be included in the broadcasting beacon of every super frame interval.

The super frame architecture of embodiments provides an opportunity to develop a snap shot of traffic requirements every super frame interval. In the illustrated embodiment, traffic requirement information is collected by point coordination via RFR sub-interval 703 provided in the upstream from the various stations desirous of obtaining access to a shared medium for data transmission. Information with respect to the resources needed (e.g., bandwidth desired, type of data to be transmitted, amount of data to be transmitted, priority or quality of service information, reservation or scheduling of data frame sub-intervals in the future, such as a series of super frames, and/or the like) is preferably communicated in the RFR sub-interval. Information with respect to the resources requested for each station presently requesting resources is preferably done in a continuous interval, here RFR sub-interval 703, in order to provide full knowledge instantaneous traffic requirements to point coordination for traffic planning.

Point coordination 601 of embodiments grants permission to particular stations requesting resources to send data frames (e.g., in a next super frame interval) via information contained in a when to send sub-interval (e.g., WTS sub-interval 704) sent in the downstream. As with the request for resources sub-interval discussed above, information with respect to when each station presently requesting resources which has been granted access to shared media is to receive and/or transmit data frames is preferably done in a continuous interval, here WTS sub-interval 704, in order to simplifying the data frame location message.

It should be appreciated that the length of the request for resources sub-interval may be set at a length determined to accommodate the requests from all stations sharing a medium. However, such an interval may result in appreciable media idle time when less than all stations are requesting resources in a particular super frame interval. Where the number of stations sharing the medium is small, then accommodating all requests for resources in a request for resources sub-interval may be desirable to avoid contention issues. Alternatively, where the number of stations sharing the medium is large or it is desired to minimize idle time, the length of the request for resources sub-interval may be set to accommodate requests from less than all stations sharing the medium, such as to accommodate a statistically relevant number of stations. However, if the length of request for resources sub-interval is short of accommodating every station requesting resources in a particular super frame interval, then stations would be competing for allocation of slots in the super frame interval and contention issues would need to be resolved.

Embodiments of the present invention implement a variable length request for resources sub-interval in order to provide a contentionless solution which minimizes idle time. For example, a need for resource sub-interval (e.g., NFA sub-interval 702) is provided according to the illustrated embodiments for discovering which stations desire access to the shared medium and thus enabling point coordination to adjust a length of the request for resources sub-interval to accommodate requests from each such station.

In operation according to a preferred embodiment, stations having a need to access the shared medium communicate a short affirmative response (e.g., an ACK) in the need for access sub-interval to inform point coordination as to how many stations have a need for resources. Additionally or alternatively, stations which do not have a need to access the shared medium may communicate a short negative response (e.g., a NAK) in the need for access sub-interval to inform point coordination as to how many stations have a need for resources. Using such short responses, the need for access sub-interval may be very short and yet accommodate all stations on the shared medium, or perhaps all stations on the shared medium statistically likely to have a need for access at any one time (as may be adjusted from time to time based upon a current number of stations, historical network activity, predicted network activity, etcetera).

Once the knowledge of which stations desire access to the shared medium is with point coordination, point coordination may then adjust the request for resources sub-interval to accommodate requests from those stations only. For example, point coordination may provide information in a beacon sub-interval of a next super frame interval (e.g., N+1th super frame interval) establishing a request for resources sub-interval of appropriate length to accommodate the requests of each station having provided an affirmative response in the need for access sub-interval of the previous super frame interval (e.g., Nth super frame interval). Because embodiments of the invention provide data such as bandwidth desired, type of data to be transmitted, amount of data to be transmitted, priority or quality of service information, reservation or scheduling of data frame sub-intervals in the future, such as a series of super frames, and/or the like for each station requesting access to the shared medium in the request for resources sub-interval, knowledge with respect to which stations desire such access and adjusting the length of the request for resources interval accordingly can result in appreciable efficiencies being realized.

As mentioned above, the timing relationship of the various functional intervals, such as NFA sub-interval 702, RFR sub-interval 703, and WTS sub-interval 704, may be different than shown in the illustrated embodiments and may be configured to optimize various performance criteria. In one example embodiment, RFR sub-interval 703 and WTS sub-interval 704 of a particular super frame interval (e.g., Nth super frame interval) are associated with data frame sub-intervals in a next super frame interval (e.g., N+1th super frame interval). In this example embodiment, NFA sub-interval 702 of a particular super frame interval (e.g., Nth super frame interval) is associated with data frame sub-intervals in the second next super frame interval (e.g., N+2th super frame interval). This exemplary embodiment results in increased delay of sending data by one super frame interval. However, overall gain in overhead is provided, assuming that the sum of requests for resources messages from all stations is larger than the sum of need for access messages from all stations plus request for resources messages from the stations requesting access to the shared medium. This is because the need for access messages of preferred embodiments is very short (e.g., a binary message of yes or no).

Embodiments of the invention provide an additional functional interval, shown in FIG. 7C as RFR scheduling sub-interval 707, for reducing idle time associated with requests for resources and for reducing delay of sending data. In the embodiment illustrated in FIG. 7C, the timing relationship of NFA sub-interval 702, RFR scheduling sub-interval 707, RFR sub-interval 703, and WTS sub-interval 704 are with respect to data frames in a next super frame (e.g., N+1th super frame interval). Such an arrangement of functional intervals introduces a yet unknown variable with respect to the length of RFR sub-interval 703 because the collection of need for access information is after the beacon sub-interval which, according to embodiments, provides information to the stations with respect to the configuration, length, etcetera of the various functional intervals, including request for resources sub-interval 703.

Accordingly, the embodiment of FIG. 7C splits the super frame interval into two time sections, shown here as the front and back section. The front section of the illustrated embodiment extends from the start of super frame interval to the start of RFR scheduling sub-interval 707, and includes need for access sub-interval 702. The back section of the illustrated embodiment extends from the start of RFR schedule sub-interval 707 to the end of the super frame interval, and includes RFR sub-interval 703. In operation according to a preferred embodiment, the schedule for the back section (e.g., the configuration, length, etcetera of the functional intervals in the back section) will be broadcasted in RFR scheduling sub-interval 707. Point coordination is thus enabled to collect need for access information and appropriately configure corresponding functional intervals, such as RFR sub-interval 703, WTS sub-interval 704, data frame sub-interval 705 (not expressly shown in FIG. 7C), and/or data frame sub-interval 706 (also not expressly shown in FIG. 7C) in the same super frame interval.

Although the aforementioned request for resources scheduling sub-interval may be utilized to reduce delay in transmission of payload data, its use introduces additional complexity into embodiments of a scheduled MAC which in some cases may not be merited by the decrease in delay realized. Accordingly, embodiments of the present invention may not implement a request for resources scheduling sub-interval.

Directing attention to FIG. 8, an embodiment of a scheduled MAC architecture of the present invention, as may be operable upon the network of FIG. 6, is shown having the timing relationship of the various functional intervals configured for optimizing one or more performance parameters. Specifically, FIG. 8 illustrates one possible super frame configuration wherein the data frame sub-intervals are placed at the beginning of the super frame intervals and the need for access, request for resources scheduling, request for resources, and when to send sub-intervals are placed toward the end of the super frame interval for providing the most up to date traffic information therein. It should be appreciated that the upstream and downstream intervals may be transmitted using separate or independent media (e.g., different radio frequency channels or separate wire lines) or may be transmitted using the same media (e.g., using time division duplexing (TDD)).

The downstream portion of the super frame interval of the embodiment illustrated in FIG. 8 begins with beacon sub-interval 701. After user terminals 101-105 on shared medium 100 decode the broadcast beacon message contained within beacon sub-interval 701 of a preferred embodiment, each such user terminal should know the super frame starting time, and thus be able to compute when to send the granted data frame, if any, from the when to send message in a previous super frame interval. Each such user terminal should also know, for the decoded broadcast beacon message, the timing for NFA sub-interval 702, the timing for RFR scheduling sub-interval 707, the timing for sending a request for resources, if any, in RFR sub-interval 703, the timing for receiving an acknowledgement, if any, in ACK sub-interval 801, for data frames sent in previous super frame, and the timing for sending an acknowledgement, if any, in ACK sub-interval 802, for data frames received in this super frame interval.

Continuing with the downstream portion of the super frame interval of the embodiment illustrated in FIG. 8, shown next is ACK sub-interval 801, providing acknowledgement frames for confirmation of data frames from user terminals 101-105 to point coordination 601 for data frames received in a previous super frame interval by user terminals 101-105 from gateway 110 in the previous super frame interval. The next functional interval shown in the illustrated downstream configuration is data frame sub-interval 705 for gateway 110 to send data frames to user terminals 101-105. In operation according to a preferred embodiment, each user terminal decodes identification in the header of the data frames to determine whether the data frame is for this station or another station.

RFR schedule sub-interval 707 follows data frame sub-interval 705 in the downstream configuration illustrated in FIG. 8. RFR scheduler sub-interval is preferably based on need for access information provided by user terminals 101-105, e.g., within NFA sub-interval 702. Point coordination 601 preferably utilizes the need for access information to determine which station needs access in RFR sub-interval 703, and builds a schedule as to who and when will be allowed access. The determination of who and when stations will be allowed access also defines the timing for the remaining super frame interval, e.g. WTS sub-interval 704 start time and possibly one or more data frames or padding bytes to fill the total duration, according to the illustrated embodiment.

The next functional interval in the downstream configuration shown in FIG. 8 is WTS sub-interval 704. In operation according to preferred embodiments, the when to send information of WTS sub-interval 704 is completed by point coordination 601 based on the request for resources information provided in RFR sub-interval 703 by ones of user terminals 101-105 having a need to access shared medium 100. Each when to send message of embodiments comprises a station identifier and a start time for inserting upstream data frames onto medium 100 in a next super frame interval.

Embodiments of the present invention operate to make sure that adjacent upstream data frames from different stations do not overlap at gateway 110. Accordingly, embodiments of the invention implement interframe spacing (e.g., the gaps illustrated between sub-intervals (which are not shown to scale)) to avoid such overlap. However, interframe space duration plays a big roll in the throughput efficiency because it appears so many times over one super frame. Accordingly, embodiments of the invention operate to minimize this spacing, as discussed in further detail below.

The upstream portion of the super frame interval of FIG. 8 starts with data frame sub-interval 706 which includes data frames from user terminals 101-105 that were scheduled by a when to send messages from a previous supper frame interval. NFA sub-interval 702, following data frame sub-interval 706 in the upstream of the illustrated embodiment, allows user terminals 101-105 to indicate whether each such station has a need for resources or not. According to a preferred embodiment, every station has a slot in NFA sub-interval 702. The need for access message from each station provided within NFA sub-interval 702 is preferably very short (e.g., a binary “YES” or “NO”) such that NFA sub-interval 702 will not greatly impact throughput on shared medium 100. It should be appreciated that use of NFA sub-interval 702 according to embodiments of the present invention eliminates contention for shared medium 100.

Continuing with the upstream portion of the super frame interval of the embodiment illustrated in FIG. 8, shown next is RFR sub-interval 703. As mentioned above, ones of user terminals 101-105 needing access to shared medium 100 (e.g., as indicated in NFA sub-interval 702) and which will be granted access (e.g., as indicated in RFR schedule sub-interval 707) will send request for resource messages (e.g., including resource requirement information such as station n and data frame length k) in accordance with information provided by messages in RFR scheduling sub-interval 707.

In operation according to a preferred embodiment, the order of sending data frames in data frame sub-interval 706 and/or data frame sub-interval 705 is the same as the station order in NFA sub-interval 702. After a station has transmitted a need for access in NFA sub-interval 702, the station waits for scheduling information provided by RFR schedule sub-interval 707 that indicates when the station's request for resources message should be submitted in RFR sub-interval 703. After a station has transmitted a request for resources in RFR sub-interval 703, the station waits for scheduling information provided by WTS sub-interval 704, which provides instructions as to when to send the data frame in a subsequent (e.g., next) super frame interval. The stations preferably provide an acknowledgment message in ACK sub-interval 802 for downstream data frames received in the same super frame interval. The order of acknowledgment messages in ACK sub-interval 802 is preferably the same order as the data frames sent.

From the above discussion, it can be appreciated that scheduled MAC architectures of embodiments facilitate an equal access scheme. However, the network administrator may be allowed to customize each station's access rights. For example, the frequency of access (e.g., every super frame or less) may be specified, as may be controlled through point coordination adjusting the frequency of need for access slots associated with a particular station provided in the need for access sub-interval in accordance with access rights specified by a network administrator. Additionally or alternatively, multiple frame access may be allowed or disallowed or even be varied as to a level of frame reservation to be provided. Such control of access rights facilitates specifying quality of service with respect to particular stations on the shared medium.

Having described various functional intervals and their timing and configuration according to embodiments above, the structure of frames for carrying data within such functional intervals according to embodiments of the invention is provided below. In addition to the super frame interval and the various functional intervals within a super frame interval being of variable length according to embodiments of the invention, the frames within the functional intervals may be of varying length according to embodiments of the invention. For example, the data frame length may be varied based upon traffic loading, the number of stations accessing the shared medium, etcetera. Embodiments of the invention operate to adjust the data frame length based upon reception quality (e.g., reception error rate), such as to shorten the data frame length as reception quality degrades and to increase the data frame length as reception quality improves, thereby reducing the size of individual data frames which must be retransmitted when received data is unrecoverable.

It is helpful in understanding frame structures as may be used according to embodiments of the invention to understand source and destination port identification schemes as may be utilized by embodiments. Any station or other node coupled to shared media may be considered as a source or as a destination, depending on whether it is sending or receiving. The physical connection or interface with the shared media preferably has a unique identifier associated therewith, although behind the physical connection or interface there may be multiple logical connections for different functions. Each function could send and/or receive data frames via the connection to the shared media. Each such function is identified on the shared media through the source/destination port number of its associated physical connection or interface, wherein that port number is unique within the network formed from a particular shared medium. In other words, a data frame having a port number in the header associated with a particular physical connection or interface would give a function using that physical connection or interface direct access to the media. This is a very attractive feature for low cost multi-function stations. According to embodiments, there are logical port numbers in the datagram to resolve the individual logical ports associated with a port number. Embodiment preferably keep the port numbers to minimum, such as by using the aforementioned logical ports associated with a port number, because each port number has the right for requesting access to the media (e.g., NFA) and thus keeping the port numbers at a minimum helps reduce the interview and scheduling complexity. Preferably, when a station submits a need for access request for total data frame lengths, the request may be with respect to multiple logical port datagrams or multiple data frames. Multiple datagrams in one data frames means all datagram goes to the same destination from the same source.

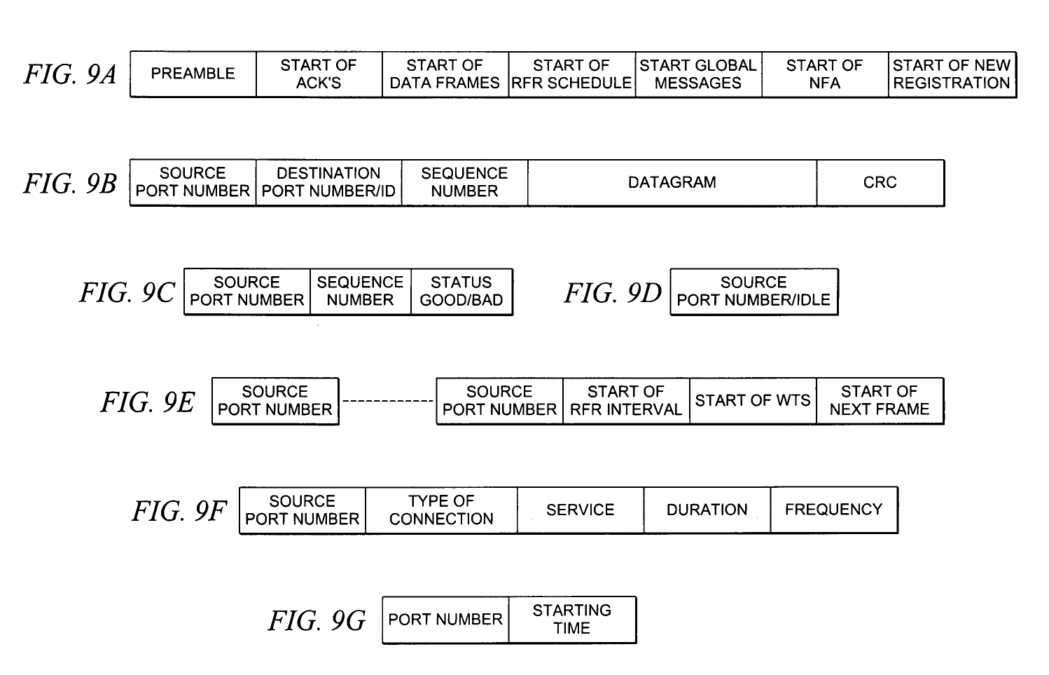

The broadcast beacon frame structure of an exemplary embodiment is shown in FIG. 9A. The illustrated broadcast beacon frame structure begins with a unique preamble word which is preferably selected so as not to be mistaken as a piece of data. The next portion of the broadcast beacon frame structure comprises messages establishing the starting times for various functional intervals within the super frame interval. It should be appreciated that the stations may calculate the functional interval lengths from the difference of two adjacent starting times. Moreover, standard message durations will be known to stations of embodiments, facilitating the calculation of functional interval lengths from the number of messages to be included in a functional interval.

The data frame structure of an exemplary embodiment is shown in FIG. 9B. The illustrated data frame structure is designed to support multiple simultaneous connections for each station. Different connections at each station (e.g., the connections of different functions operable at the station) are identified by individual unique (e.g., logical) port numbers. Such logical port numbers may be a sub-layer of the physical port number according to embodiments of the invention. In other words, each receiver may implement two layers of sorting, the first sorting layer being the port number, the second layer being the logical port number. Regardless of the underlying scheme, each connection is preferably identified by source port number and destination port number, wherein destination means the location where the data frame is terminated without mention of transit locations. Accordingly, the data frame header of the illustrated embodiment includes source port number and destination port number for connection identification.

In operation according to a preferred embodiment, each station includes two connection mapping tables; one table including its own station ID and port number versus the functions operating on the station, the other table comprises destination information, such as station ID, supporting functions, and/or the like. To set up a connection, the header preferably includes destination station ID and functions instead of destination port number, because the station originating the connection may not have knowledge of the destination station's port number initially. As the connection is established, the source station preferably replaces the destination station's ID in the data frames with the destination port number.

The data frame header illustrated in FIG. 9B is adapted to track the transaction sequence in case data frames arrive out of order or retransmission for missing frame. Specifically, the data frame structure header of FIG. 9B includes a sequence number for transaction sequence tracking.

The data frame structure of the illustrated embodiment begins a header followed by datagram, wherein the datagram preferably comprises payload data. The datagram may vary in length from 64 bytes to 5000 bytes, generally being on the order of 1000 bytes, according to an embodiment of the invention. The data frame structure of the illustrated embodiment further comprises error detection and/or correction, shown here as a circular redundancy code checksum, to detect transmission errors and/or to provide recovery of data without retransmission.

The acknowledgment frame structure of an exemplary embodiment is shown in FIG. 9C. The illustrated acknowledgment frame structure provides an acknowledgment message to state data frames have been delivered correctly or incorrectly. The illustrated acknowledgement frame structure comprises source port number and sequence followed by the status of the data frame as received. Preferred embodiments apply such acknowledgment messages only to non-real time data frames, because real time data frames (e.g., voice over Internet protocol (VoIP) data streams) typically do not benefit from the retransmission of a lost or corrupted data frame.

The need for access frame structure of an exemplary embodiment is shown in FIG. 9D. As mentioned above, each station preferably has its own slot in the need for access sub-interval. The sequence assignment within the need for access sub-interval is preferably done during the initial set-up. From the broadcasting beacon at the beginning of the super frame interval, the need for access slot location of each station can be computed from the starting time of the NFA sub-interval based on the fixed duration for each acknowledgement. The need for access frame structure of the illustrated embodiment is a source port number for “yes,” “idle,” or “no show.” For example, a station, knowing it's slot time, it can respond with “yes,” meaning it is active, “idle,” meaning it is “on,” but not in active mode or as a “no show,” meaning it is not responding because the station is off, asleep, or absent.

Embodiments of the invention provide otherwise unassigned slots in the need for access sub-interval to facilitate new stations accessing the network, such as using plug and play plug declaration to point coordination. Accordingly, stations are preferably equipped with a source port number for initialization on the network. Stations may additionally be equipped with a destination port number, such as that of a gateway hosting point coordination, for use in initialization on the network. Additionally or alternatively, a destination port number associated with point coordination may be broadcast, such as within the broadcast beacon, for use in initialization on the network.

The request for resources schedule frame structure of an exemplary embodiment is shown in FIG. 9E. In operation according to a preferred embodiment a request for resources scheduling algorithm of point coordination collects all source port numbers with “yes” response in the need for access sub-interval, preferably discarding the idle messages and no response. The request for resources scheduling algorithm will preferably resend, in the request for resources scheduling sub-interval, those source port numbers which are to be provided resources in the sequence that the stations are assigned time slots in the request for resources sub-interval and/or the data frame sub-interval(s). Accordingly, the request for resources schedule frame of the illustrated embodiment includes a plurality of source port number messages. Additionally, the request for resources schedule frame of the illustrated embodiment further includes information with respect to the start of the request for resources sub-interval, the start of the when to send sub-interval, and the start of the next super frame interval to thereby define the structure of the second part of the super frame interval as described above.

The request for resources frame structure of an exemplary embodiment is shown in FIG. 9F. Stations listed in the request for resources schedule sub-interval preferably send the information shown in the request for resources frame structure in the appropriate time slot of the request for resources sub-interval. The information included in the request for resources frame structure of the illustrated embodiment includes source port number, type of connection and service requirement, duration and frequency. The type of connection may include information such as to indicate a single frame transaction or multiple frame transaction (e.g., reserve data frames for some period of time in the future, for some identified number of data frames, for a predetermined amount of data, until a request to terminate the link is provided by the station, etcetera). A purpose of multiple frame reservation is to avoid the process of continuously going through need for access and request for resources where a persistent link is desired (e.g., to accommodate a connection based link for real time communications). The service designated in the request for resources frame structure may comprise information such as real time or non-real time. The duration designated in the request for resources frame structure may comprise information such as the amount of the data frame sub-interval and/or the number of period of requested data from sub-intervals to be reserved for this station's use. It should be appreciated that, if the duration changes widely from one data frame to another, multiple frames transaction may not be too useful. However, such multiple frame transactions may be particularly useful where the duration is substantially constant, such as may be the case when transmitting a voice signal. The frequency designated in the request for resources frame structure may comprise information such as the frequency of reserved data frames, e.g., each super frame interval, every other super frame interval, etcetera.

The when to send frame structure of an exemplary embodiment is shown in FIG. 9G. When to send frames of a preferred embodiment comprise an instruction to let the stations, which have made a request for resources and which have been granted access to the shared medium, know when to send their data. Accordingly, the when to sent frame structure of the illustrated embodiment comprises a port number and the start time for sending data.

Having described configurations of super frames and frames within the various functional intervals comprising super frames of embodiments of the invention, frame exchange protocols as may be implemented according embodiments of the invention will be provided below. It should be appreciated that various frame exchange protocols may be implemented for performing particular transactions, such as to set up a connection, exchanging data frames, registration of new stations, etcetera. Examples of frame exchange protocols for providing exemplary transactions are provided herein. However, as one of ordinary skill in the art will appreciate, the frames and frame structures of the present invention may readily be utilized with respect to different frame protocols and/or for providing transactions in addition to or in the alternative to those described.

For any communication between to points, it is typically desirable to perform a handshake before data transfer. For example, the destination station may not be powered on or may want to be selective with respect to what stations can connect to it. Handshaking may comprise a message from a source station to a destination station which identifies the source station and, if the destination station accepts the connection, is responded to by the destination station with some form of information indicating the connection has been accepted. In operation according to embodiments of the invention, an initial message sent to a destination station includes the source station's port number and the destination ID, wherein an affirmative response by the destination station includes the destination port number. Having received a destination port number from the destination station may indicate to the source station that the connection has been accepted by the destination station. Accordingly, the source station may then use the destination port number for subsequent data frame transmission, although the destination ID was used in the initial connection request handshake transaction.

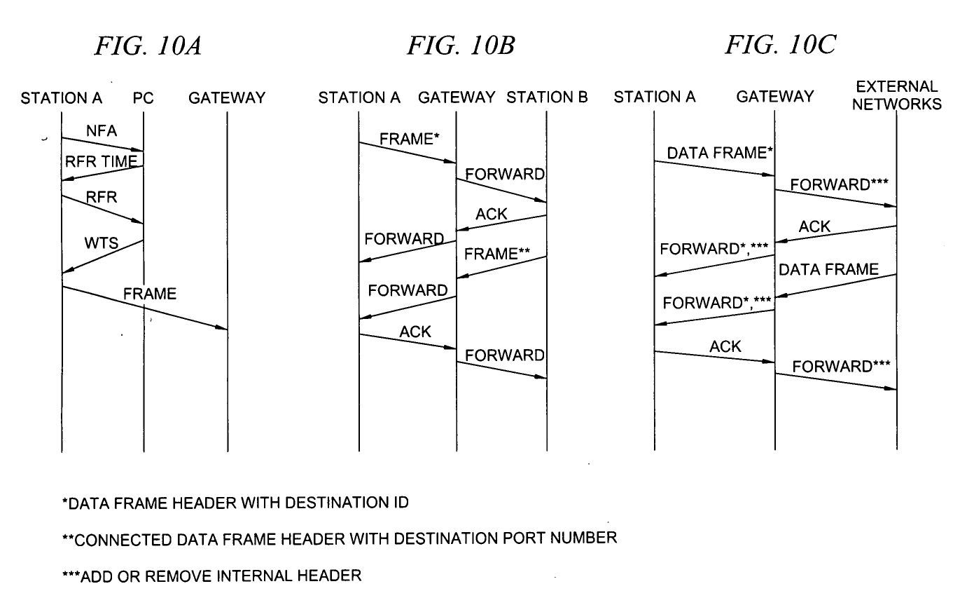

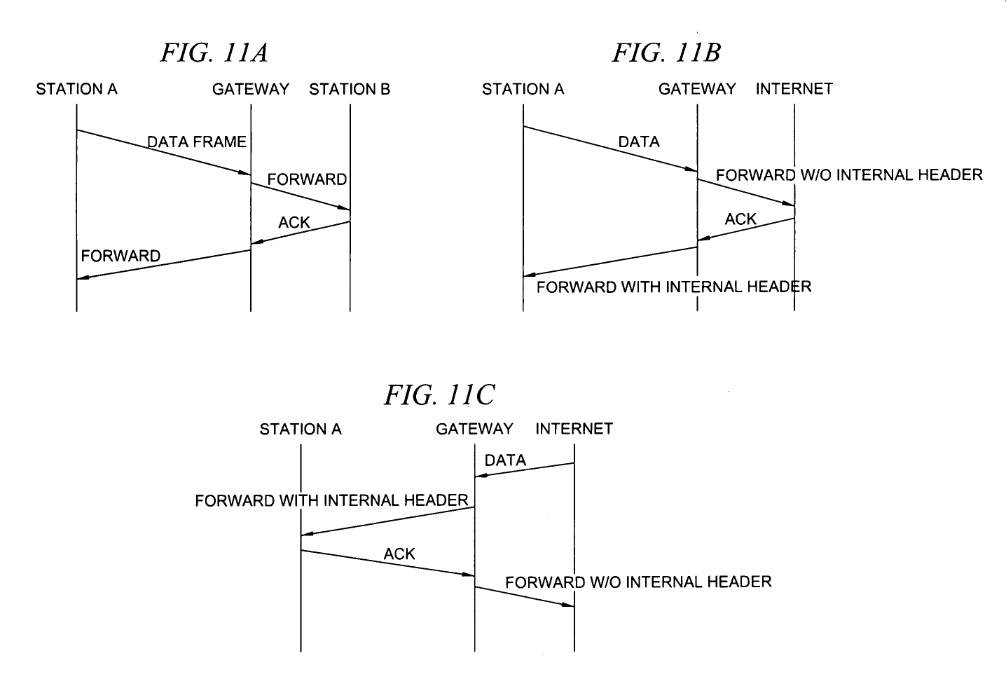

FIGS. 10A-10C and 11A-11C illustrate frame exchange protocols for providing various transactions. It should be appreciated that, although the embodiments illustrated in these figures provide an infrastructure configuration wherein all traffic is through the gateway or other centralized node (e.g., access point, bridge, etcetera), the concepts of the present invention are applicable to distributed configuration where frames are transmitted directly from one station to another.

Directing attention to FIG. 10A, a frame exchange protocol for accessing a shared medium to transmit a data frame is shown. The frame exchange protocol of FIG. 10A comprises an exchange of information in need for access, request for access schedule, request for access, when to send, and data frames in accordance with operation as described above. In the frame exchange protocol illustrated in FIG. 10A, the scheduled MAC architecture operable in the process would guarantee the data frame will be sent in next super frame interval, assuming that the media is not overloaded. It should be appreciated that the frame exchange protocol of FIG. 10A applies to both infrastructure and distributed network configurations because, according to embodiments of the invention, the access to media is controlled by point of coordination in each such network configuration.

Transmission of a data frame is typically not useful without a destination station being ready to receive the data frame. FIG. 10B shows a frame exchange protocol for establishing a connection with a destination station for receiving the data frame, accordingly the data frame shown therein preferably comprises handshaking information as discussed above. The data frame from station A shown in FIG. 10B may correspond to the data frame shown in FIG. 10A, and thus the frame exchange protocol of FIG. 10A may be utilized to access the shared medium for transmission of this data frame. As shown in FIG. 10B, the data frame is transmitted from station A to the gateway and then forwarded on to station B (it being assumed in this illustrated embodiment that station A and station B are establishing an intra-network connection). Consistent with embodiments described above, station B responds with an acknowledgement frame and a data frame (here preferably containing a port number of station B for the connection) transmitted through the gateway to station A. Station A responds with an acknowledgment frame in the illustrated embodiment, which is also transmitted trough the gateway.

Communication with stations of an external network (e.g., a network disposed upon the left side of gateway 110 in FIG. 7, may be accomplished by encapsulating external network protocol frames (e.g., header, data frame, etc.) within the data frames of super frame intervals of a scheduled MAC of embodiments of the present invention. That is, the external network protocol frames may comprise payload within a data frame sub-interval of a super frame interval. In operation according to a preferred embodiment, an external interface used for external network connection is treated as logical station. Accordingly, such an external network interface has its own port number according to embodiments. Thus a connection may be established between stations within the scheduled MAC network and the external interface and between stations of the external network and the external network interface, with the gateway arbitrating communication between. For example, the internal header will be either striped from (data going from the scheduled MAC network to the external network) or inserted on (data going from the external network to the scheduled MAC network) data frames directed to the external network interface port number. The gateway will preferably then pass the reconfigured data on the appropriate network for delivery to the actual destination.

FIG. 10C illustrates a frame exchange protocol for communication between stations of a scheduled MAC network of embodiments of the invention and stations of an external network. According to the illustrated embodiment, a data frame encapsulating a frame of the external network protocol is transmitted from station A to the gateway, wherein the gateway strips the scheduled MAC header information from the data frame and places the remaining data in the external network protocol on the external network. The data frame is routed to the appropriate station of the external network according to the external network protocols. The station of the external network responds with an acknowledgement frame and a data frame (each according to the protocol of the external network) which are transmitted to the external interface of the gateway. The gateway encapsulates these frames with headers appropriate to the scheduled MAC network and forwards them to station A. Station A responds with an acknowledgment frame in the illustrated embodiment, which is also transmitted trough the gateway as described above.

Once a connection is established, such as using the foregoing frame exchange protocols, data communication may be carried out. FIGS. 11A-11C show data frame exchange for data communication according to embodiments of the invention. Specifically, FIG. 10A illustrates transmission of a data frame from station A to station B through the gateway for data communication using a connection therebetween as may have been established in accordance with the frame exchange protocol of FIG. 10B. FIG. 10B illustrates transmission of a data frame from station A to a station on the Internet through the gateway for data communication using a connection therebetween as may have been established in accordance with the frame exchange protocol of FIG. 10C. FIG. 10C illustrates transmission of a data frame from a station on the Internet to station A through the gateway for data communication.

When a new station is connected to the shared medium, there is no need for access slot for that particular station in the need for access sub-interval according to embodiments of the invention. Point coordination may be made aware of the new station in a variety of ways. The new station preferably has a unique set of port numbers, such as may be assigned by a network administrator or as may be provided as a unique MAC number. Having unique port numbers, the new station can be identified to point coordination for adding an associated time slot to the need for access sub-interval. A network administrator may register the station with point coordination, such as by inputting the port numbers, or the station may be automatically recognized, such as through use of a plug and play protocol. Once point coordination has been made aware of the new station, the broadcast beacon preferably broadcasts this new station's port numbers with a need for access time slot in the need for access sub-interval. The new station may respond with a “yes” message, and then the new station can communicate with point coordination to complete the whole registration process, if desired. Once the new station can access the need for access sub-interval, the new station can request and receive access to the shared medium as described above with respect to the other stations on the shared MAC network.

If there is a large number of inactive stations, then a large space of need for access slots in the need for access sub-interval may be allocated which are unused. Accordingly, embodiments of the invention operate to retire these stations from need for access slot allocation, such as upon notification by a station that it is being taken off line or after a predetermined period of non-use with respect to an associated need for access slot. Embodiments of the present invention implement a reactivation scheme in order to again provide need for access slots for a previously inactive station.

An inactive station can be categorized in at least two classes. Stations with no signal in an associated need for access slot are likely in a power off or sleep mode. These stations may not require fast access once they are back on line. Stations responding with “NO” in an associated need for access slot after a period of time are likely in an idle mode. These stations may require a fast access capability. A reactivation scheme of embodiments of the invention allocates a few slots in the need for access sub-interval to a subset of the idle or inactive stations, thereby periodically providing access to such stations. In order to provide faster access with respect to idle stations, reactivation schemes of embodiments may operate to include those stations in the need for access sub-interval time slots more frequently than the fully inactive stations.

Supporting short message service is typically a problem in existing wired and wireless LANs because the over head is very high, making support of short message service inefficient. The inefficiencies are further exasperated where there is a real time requirement with respect to the short message service. However, scheduled MAC architectures of embodiments of the present invention can readily support such services for intra-network communication, because of the short overhead (headers and interframe space) and multiple frame reservation scheme.

The scheduled MAC architecture of embodiments of the present invention may be used as a direct replacement for existing MAC architectures, such as Ethernet MAC protocol, IEEE 802.3, and WiFi MAC protocol, IEEE 802.11. However, scheduled MAC architectures of embodiments of the invention decouple the MAC layer from the physical layer such that the physical interface of Ethernet and WiFi could remain the same. Accordingly, infrastructure, such as routers, switches, gateways, bridges, user terminals, etcetera, may readily be adapted to implement a scheduled MAC of an embodiment of the present invention.

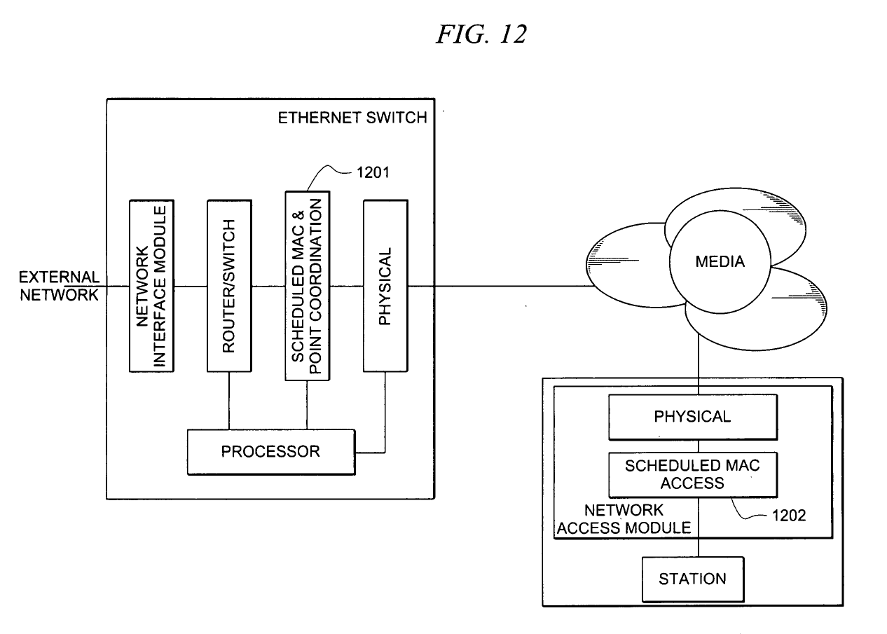

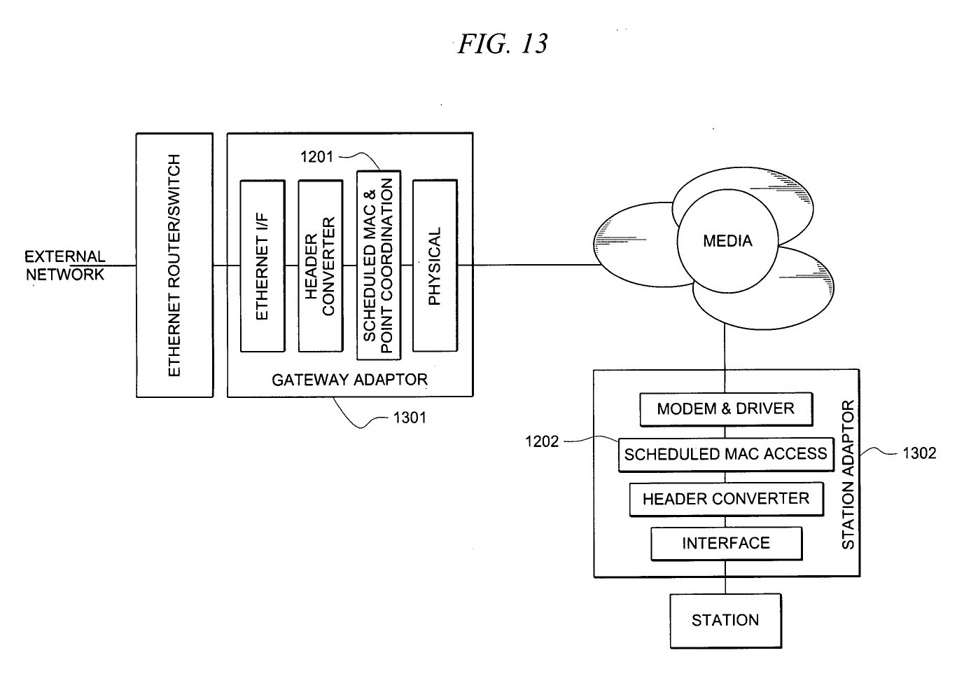

Directing attention to FIG. 12, an example of adaptation of Ethernet or WiFi stations to implement a scheduled MAC architecture of an embodiment of the present invention. In the embodiment illustrated in FIG. 12 the station configuration is substantially the same as that of Ethernet and WiFi stations except that the MAC function has been replaced by scheduled MAC algorithms of an embodiment of the present invention, shown as scheduled MAC point coordination 1201 and scheduled MAC access 1202. FIG. 13 shows an alternative embodiment, wherein protocol adaptors, shown here as gateway adaptor 1301 and station adapter 1302, are built around the media to make the scheduled MAC architecture transparent to standard network equipment.

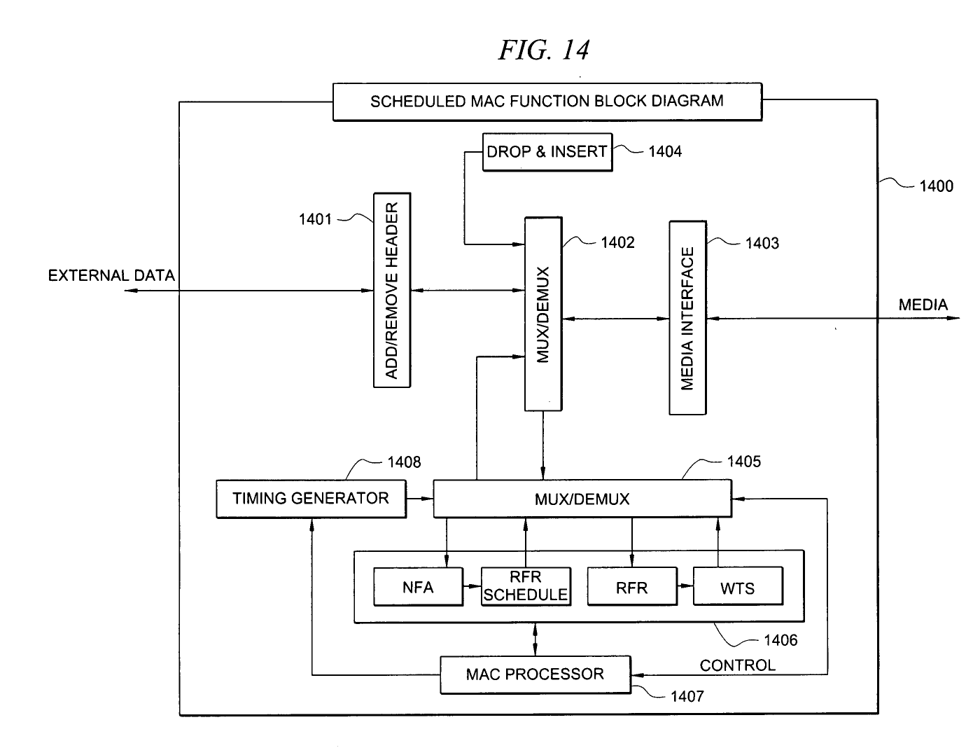

FIG. 14 shows a scheduled MAC functional block diagram providing detail with respect to an embodiment of circuitry providing scheduled MAC and point coordination, such as may correspond to that utilized to provide scheduled MAC and point coordination 1201 of FIGS. 12 and 13. The functional blocks illustrated in FIG. 14 may be implemented in software, firmware, and/or well known electronic circuits (e.g., controllers, multiplexers, demultiplexers, memories, buffers, etcetera) to provide operation as described herein. Additionally or alternatively, the functional blocks illustrated in FIG. 14 may be implemented in proprietary circuits (e.g., application specific integrated circuits (ASICs), programmable gate arrays (PGAs), etcetera). The combination of the functional blocks illustrated in FIG. 14 shall be referred to herein as MAC chip 1400 for convenience, although some or all of the functional blocks therein may not be implemented in an integrated circuit, as stated above.

In operation of MAC chip 1400 if the illustrated embodiment, when external data (e.g., data associated with stations of an external network) comes into or leaves MAC chip 1400, the internal header will removed or insert respectively by add/remove header block 1401. Removal of header is straight forward according to embodiments of the invention. However, insertion of a header is more difficult, because it has to be known which internal header should be used. This problem is solved according to embodiments using an existing network transition point, such as TCP/IP network to Ethernet network.

MAC chip 1400 intended to be used in the gateway or the scheduling control center, of the illustrated embodiment includes a multiplexer and demultiplexer function, shown as mux/demux 1402, where the data and control frames are combined or separated respectively. The media side of mux/demux 1402 of the illustrated embodiment is coupled to a media interface module, shown here as media interface 1403, which will place signals onto and/or extract signals from the shared medium for which MAC chip 1400 provides a scheduled MAC architecture. The control function messages of embodiments are carried in control frames in the same super frame interval as are data frames, and they preferably have the same format. However, the control function messages preferably differ from the data frames in that the connection associated therewith terminates at the gateway or other station hosting point coordination (e.g., control function messages have a unique port number of the gateway).

Control function messages demultiplexed from the media bit stream by mux/demux 1402 of the illustrated embodiment are provided to a further multiplexer and demultiplexer function, shown as mux/demux 1405. Mux/demux 1405 multiplexes and demultiplexes the various control function messages for processing by MAC super frame management, provided by MAC frame management 1406 in the illustrated embodiment. MAC frame management 1406 of the illustrated embodiment operates under control of a MAC controller, shown here as MAC processor 1407. MAC processor 1407 coordinates regular tasks for each super frame, such as scheduling, message formatting, and timing interval generation (e.g., using timing generator 1408). MAC processor 1407 of embodiments further coordinates unscheduled tasks, such as registration/deregistration of stations, maintenance, fault monitoring, etcetera.

Drop and insert 1404 of embodiments provides a relay function as may be used in various cases. For example, as relay function of drop and insert 1404 may be used in a gateway in the infrastructure configuration where all data frames are transmitted through the gateway to the destination, wherein the drop and insert 1404 is implemented for all intra-network traffic. In another application drop and insert 1404 is used in a relay function for communication between station A and B, wherein station A transmission cannot reach station B and visa versus but station C can reach both station A and B. In operation according to embodiments, station C originated from both station A and B and station C will use the drop and insert 1404 to retransmit the data frame to the proper one of stations A and B.

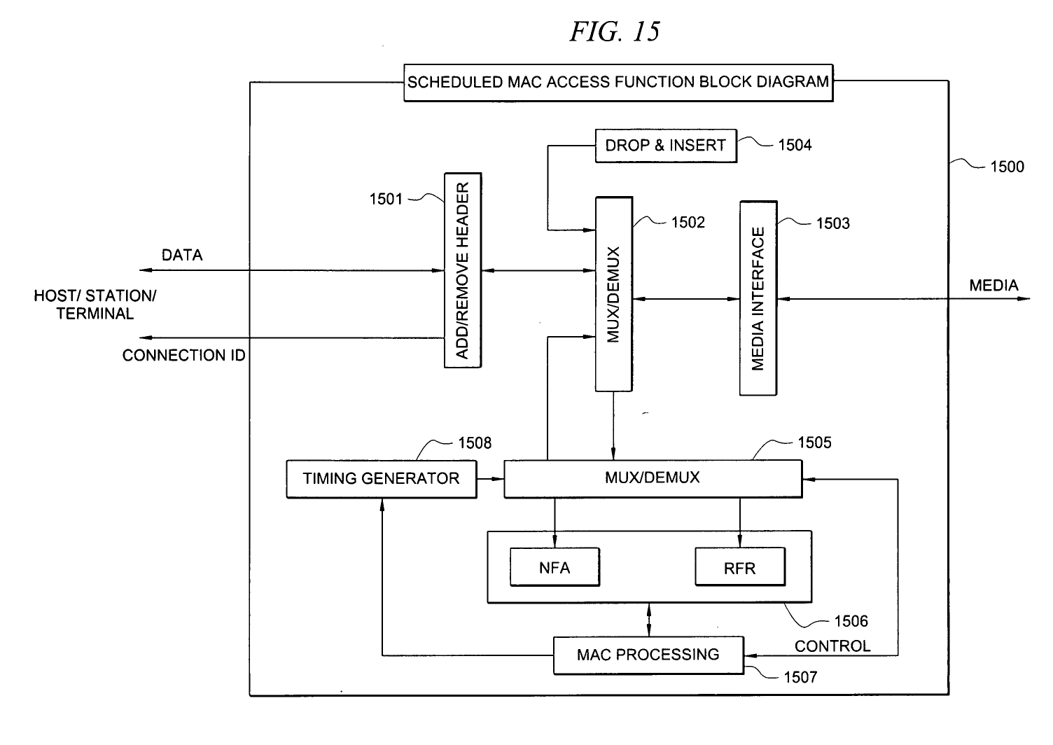

FIG. 15 shows a scheduling MAC access functional block diagram to be used in the stations providing detail with respect to an embodiment of circuitry providing scheduled MAC access, such as may correspond to that utilized to provide scheduled MAC access 1202 of FIGS. 12 and 13. As with the functional blocks of FIG. 14, the functional blocks illustrated in FIG. 15 may be implemented in software, firmware, and/or well known electronic circuits (e.g., controllers, multiplexers, demultiplexers, memories, buffers, etcetera) and/or in proprietary circuits (e.g., application specific integrated circuits (ASICs), programmable gate arrays (PGAs), etcetera). The combination of the functional blocks illustrated in FIG. 15 shall be referred to herein as MAC chip 1500 for convenience, although some or all of the functional blocks therein may not be implemented in an integrated circuit, as stated above.

Scheduled MAC functional blocks of circuitry providing scheduled MAC access, such as may correspond to that utilized to provide scheduled MAC access 1202 of FIGS. 12 and 13, of embodiments may be substantially the same as those illustrated with respect to MAC chip 1400, preferably having scaled down functions. For example, the header insertion is managing a small quantity of headers in scheduled MAC access 1202 of embodiments and thus add/remove header 1501 may provide functionality as described above with respect to add/remove heater 1401, although this functionality may be scaled accordingly. Similarly, multiplexer and demultiplexer functionality provided by mux/demux 1502 of the illustrated embodiment may be similar to that of mux/demux 1402, although this functionality is preferably scaled to correspond to the reduced quantity of control function messages and data frames associated with operation of scheduled MAC access 1500. The media side of mux/demux 1502 of the illustrated embodiment is coupled to a media interface module, shown here as media interface 1503, which will place signals onto and/or extract signals from the shared medium for which MAC chip 1500 provides a scheduled MAC architecture. Drop and insert 1504 preferable operates as described above with respect to drop and insert 1404.

Control function messages demultiplexed from the media bit stream by mux/demux 1502 of the illustrated embodiment are provided to a further multiplexer and demultiplexer function, shown as mux/demux 1505. Mux/demux 1505 multiplexes and demultiplexes the various control function messages for processing by MAC super frame management, provided by MAC frame management 1506 in the illustrated embodiment. MAC frame management 1506 of the illustrated embodiment operates under control of a MAC controller, shown here as MAC processor 1507. MAC processor 1507 coordinates various tasks for each super frame, such as scheduling, message formatting, and timing interval generation (e.g., using timing generator 1508) and tasks which may be performed periodically or irregularly, such as registration/deregistration of a corresponding station, maintenance, fault monitoring, etcetera.

According to embodiments of the invention, MAC chip 1500 providing scheduled MAC access functionality may not utilize (or include) scheduling and keeping track of time for sending packets (e.g., omit timing generator 1508). The scheduled MAC architecture for this embodiment would simplify the stations, transferring much of the complexity to the gateway or other point coordination host. Such an embodiment may be preferable because there will typically be only one gateway (or other point coordination host) and many other stations.

To aid in appreciating the efficiency of contentionless media access control provided by operation of a scheduled MAC of embodiments of the present invention, the following shows a comparison of the overhead cost for sending one data frame with different MAC schemes.

Average PCF overhead for sending one data frame:
2SIFS+Poll+ACK+((N−n)(2SIFS+Poll+ACK))/n

Average DCF overhead for sending one data frame:
DIFS+3SIFS+RTS+CTS+ACK

Average scheduled MAC overhead (without RFR scheduling sub-interval) for sending one data frame:
2IFS+NFA+RFR+WTS+ACK+((N−n)(IFS+NFA))/n

Average scheduled MAC overhead (with RFR scheduling sub-interval) for sending one data frame:
2SIFS+NFA+RFR schedule+RFR+WTS+ACK+((N−n)(IFS+NFA))/n
where:

N is the total number of stations;

n is the number of stations that has data to send; and

IFS is the interframe space.

Note that the downstream in scheduled MACs of embodiments of the present invention does need interframe spacing (IFSs), because the when to send (WTS) information is a continuous block.

It can be seen from the above that the average overhead is very favorable for scheduled MACs of embodiments of the present invention for providing a contentionless media sharing scheme. Moreover, through implementation of optimization algorithms with respect to data frame reservation, IFS optimization, traffic flow management and header simplification, the above illustrated average overhead advantages with respect to scheduled MACs of embodiments of the present invention may be further enhanced.

Some underlying considerations for use in configuring and optimizing a scheduled MAC of the present invention include super frame interval and functional interval length, arrangement of functional intervals within a super frame interval, and association of functional intervals between super frame intervals. Every functional interval in the super frame interval, including the functional intervals' length, is preferably different from super frame interval to super frame interval for optimizing the throughput, latency, and traffic flow management for fairness. Some basic rules for guiding an optimization algorithm used in configuring the timing relationship of the various functional intervals include: The super frame should be as short as possible with minimum padding bits; The maximum super frame length should be set by the upstream needs, but the limit on the maximum length is set by the operation needs; and The minimum super frame length should be set by the downstream needs (e.g., the super frame length may be set by the need to complete all need for access requests in one, preferably earliest, super frame). Additional considerations useful in configuring a scheduled MAC of the present invention for optimized performance include supporting plug and play access to a new station (e.g., a new station can declare itself to point coordination for inclusion in the super frame configuration, such as to add a time slot in a need for access sub-interval) and supporting real time and non-real time data frames (e.g., a station may reserve a series of data frames to provide a connection based type link for real time communication, whereas other data may be non-real time accommodating higher latency and thus allowing deferred scheduling). Embodiments of the invention configure the functional intervals' location and length for optimization with respect to different types of physical layers.

Scheduled MAC architectures of embodiments of the present invention provide a foundation for how the MAC layer should operate. Preferred embodiments implement one or more optimization algorithms, such as may be operable upon MAC processor 1407 of FIG. 14, which operate enhance the MAC performance by take advantage of scheduled MAC platform flexibility.

For example, an optimization algorithm may be provided to optimize scheduled MAC performance parameters, such as for optimized throughput, by varying the super frame interval length. Super frame interval length preferably corresponds to the data frame requirements identified in request for resources sub-intervals of embodiments of the invention. Accordingly, super frame interval lengths are longer if the traffic is heavy and shorter when the traffic lighter. With a shorter super frame interval, the frequency of the request for resources sub-interval will increase. However, the overhead will be reduced by shortening the request for resources, when to send, and acknowledgment sub-intervals. Although the total throughput will decrease, the throughput per station will increase, thereby maintaining high throughput independent of number of stations. This optimization algorithm is considered neutral, because it has no negative impact with respect to other MAC performance parameters, such as access fairness, contention control, network stability, and latency.

Additionally or alternatively, an optimization algorithm may be provided to optimize scheduled MAC performance parameters, such as latency, through implementing an access reservation algorithm. Access reservation provided according to embodiments of the invention means that requests for resources may request multiple data frames at once and/or a string of data frames in future super frames. Such multiple data frame reservations will reduce the traffic in the request for resources sub-interval of embodiments of the invention while allowing stations to reserve desired bandwidth. A string of resource reservations in future super frames facilitated by an access reservation algorithm of embodiments is especially attractive for real time traffic where a continuous and regular traffic is required. For example, a scheduled MAC implementing an access reservation algorithm may plan data frames for a particular station very close to regular occurrences. Using such resource reservations, latency may be minimized while reduction in the request for resources loading is decreased.

Additionally or alternatively, an access reservation algorithm may be utilized to provide more fairness to high and low traffic stations by reserving data frame slots with respect to appropriate stations. Moreover, an access reservation algorithm of embodiments of the invention maintains the throughput regardless of number of stations. For example, the throughput for a super frame would be total data frames divided by the sum of total over head and total data frames. Assuming a super frame has n data frames, through operation of an access reservation algorithm, these n data frames could be from one to n stations. This means the throughput capacity does not change with the number of stations. This algorithm is considered neutral because it would not negatively impact other performance parameters such as access fairness, contention control, throughput, and network stability.

An optimization algorithm may additionally or alternatively be provided to optimize scheduled MAC performance parameters, such as access fairness, through implementing traffic flow control. A traffic flow control algorithm of embodiments of the invention may operate to ensure the fairness of access and that throughput is maintained when the traffic is reaching full capacity. In operation of a scheduled MAC architecture of an embodiment of the invention, all the resources requested will be granted in next super frame interval. As traffic increases, the super frame interval length gets longer. A long super frame interval reduces opportunities for new requests to be made. Accordingly, embodiments of the present invention set a maximum super frame interval length a threshold in terms of the super frame length. For example, a maximum super frame interval length threshold is set according to a preferred embodiment based on the minimum access rate for each station. In operation according to an embodiment, when the traffic causes the super frame interval length to exceed the threshold, action may be taken for the next super frame as described below traffic flow control algorithm operation. Accordingly, traffic flow control algorithms of embodiments of the present invention maintain the opportunities for new access above an acceptable rate, without reducing the overall throughput.

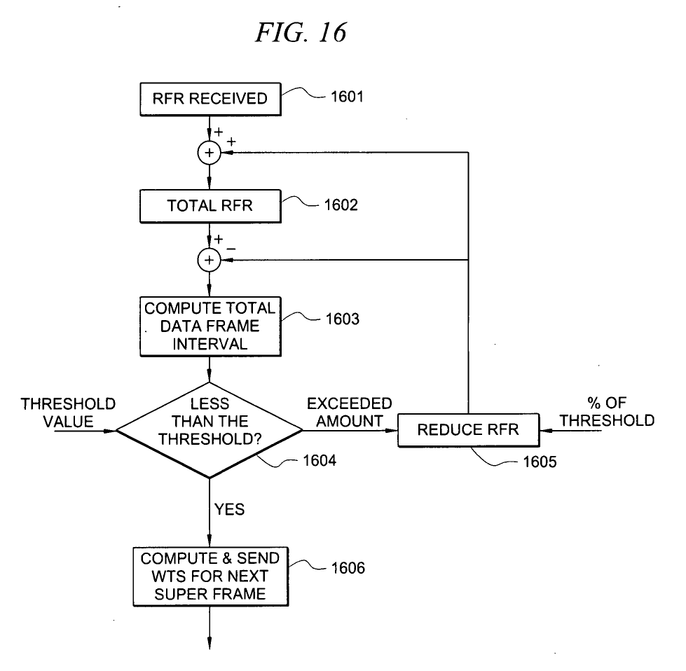

Directing attention to FIG. 16, a flow diagram of operation of a traffic flow control algorithm of an embodiment of the invention is shown. The illustrated flow diagram begins at block 1601 wherein request for resources are received. In operation according to a preferred embodiment, the request for resources is updated every super frame interval. Accordingly, at block 1602 of the illustrated embodiment the total request for resources are determined from the current request for resources and the remaining unsatisfied requests for resources (as provided by block 1605). That is, the total request for resources comprises the sum of request for resources for a current super frame interval and the request for resources left over from the previous super frame.

At block 1603, the total data frame length is computed from the total request for resources. If the total data frame length is less than the traffic flow control threshold (e.g., will not result in an access rate for each station being below a minimum), then the total request for resources may be accommodated and when to send information may be determined to accommodate the requests in the next super frame interval at block 1606. However, if the total data frame length is larger than the threshold, then the excess data frame length is computed and when to send information for those requests for the requests for resources than can be accommodated in the next super frame interval are determined at block 1605. The remaining requests for resources are preferably accommodated in the second next super frame. The determination of the amount of data frames to send and the amount to carry to second next super frame could be done by a factor. The factor could be could be small and increase, if the over load persists. However, any priority data frames should be on the first list.

An optimization algorithm may additionally or alternatively be provided to optimize scheduled MAC performance parameters, such as throughput, through implementing an interframe space algorithm. The interframe space (IFS) is defined as the idle space separates two consecutive frames, whether super frames or frames within a super frame. This space is desirable to ensure that two consecutive frames do not overlap at the point of detection (e.g., the gateway). However, the size of the interframe space has a major impact on throughput because it is typically used for every frame. Accordingly, interframe spacing algorithms of embodiments of the present invention operate to automatically optimize the interframe spacing with changes of the network environment.

Currently, Ethernet and WiFi use the interframe space for access control. For example, if station 1 waits idle period of the shortest interframe space (SIFS) interval to access the medium, whereas other stations have to wait for longer interval than the shortest interframe space to access the medium, then station 1 has the privilege to access the medium before the other stations. Back off provisions of a collision detection system may implement varying time periods added to a shortest interframe space interval for access control in an attempt to increase fairness.

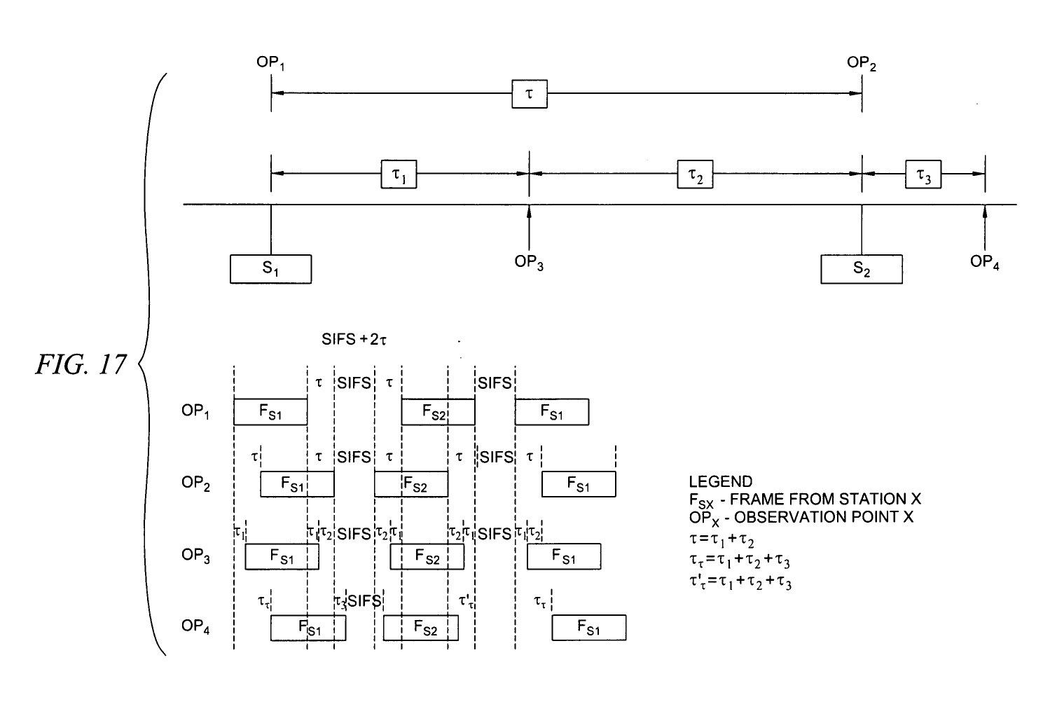

Current MAC architectures do not take the propagation delay in the media into account. However, it is important to include the propagation delay to reflect what is happening in the real operational environment. Assuming station 1 and 2 are communicating with a propagation delay of τ over a media as shown in FIG. 17. When station 1 sends a frame to station 2, station 2 will receive the frame at a time τ later. In responding, station 2 sends a frame to station 1 after waiting for the shortest interframe space, which will arrive at station 1 at a time τ later, and so on. However, the interframe spacing is a function of observation point along the medium because each station sees the network activity of the other stations at different respective times. The following table shows the interframe spacing versus observation points:

| Pair of | | IFS at observation Point | | | |
|---|---|---|---|---|---|
| consecutive Frames | | | | Between | Outside of |
| First | Second | Station 1 | Station 2 | Stations | stations |
| Station 1 | Station 2 | SIFS + 2τ | SIFS | SIFS + 2τ₂ | SIFS |
| Station 2 | Station 1 | SIFS | SIFS + 2τ | SIFS + 2τ₁ | SIFS + 2τ |

Where τx is the delay between station X and the observation point, and τ is the sum of τ₁ and τ₂.

In a network with many stations, the interframe spaces are a little more complex to compute, especially one has to know the relationship of the observation point to stations (i.e., whether the observation point is in between stations or outside of the stations). In current Ethernet and WiFi MAC architectures, the shortest interframe space and delay are constants in time. Accordingly, as the raw bit rate increases, the same frame size will be shorter. If the shortest interframe space and τ do not scale with the raw bit rate, then the shortest bit rate and τ could be a significant factor in degrading the throughput.

In the scheduled MAC architecture of embodiments of the invention, there is no need to use interframe spaces as a fairness control. Accordingly, an interframe space algorithm of embodiments of the present invention causes the interframe spacing to be scaled with the raw bit rate. In other words, interframe spacing would not be in unit of real time scale (e.g., micro-second), but may be in terms of the raw bit rate. Such embodiments make the throughput percentage independent of raw bit rate. The interframe spacing of such embodiments could be very small, as long as the frames do not overlap at the point coordination host interface, e.g., the gateway input.

Various techniques may be implemented by interframe space algorithms of embodiments of the invention to provide optimized interframe spacing. It should be appreciated that embodiments of the present invention may implement one or more such techniques alone or in combination, if desired.

One method implemented for optimizing interframe spacing comprises determining the maximum media delay that is allowed for the network and to use twice this maximum delay plus a margin (e.g., 10%) as the interframe space as defined in time. From this interframe space time, the equivalent number bits can be calculated. If this number of bits is acceptable (e.g., if the overhead including the beacon NFA, RFR, WTS, ACK and interframe spacing is approximately 20% of the bit rate or less), a constant interframe space could be implemented for all frames regardless which station is sending. This algorithm is most likely to be desirable for use with raw bit rates of 10 Mb/s or less. If, however, the number of bits for the interframe space is unacceptable, the margin may be reduced, a variable length interframe space may be used, etc.

A more sophisticated solution to interframe optimization comprises compensating for propagation delay. Accordingly, embodiments of the present invention implement an interframe space matrix for controlling the sending time of particular stations, thereby implementing variable length interframe spacing.

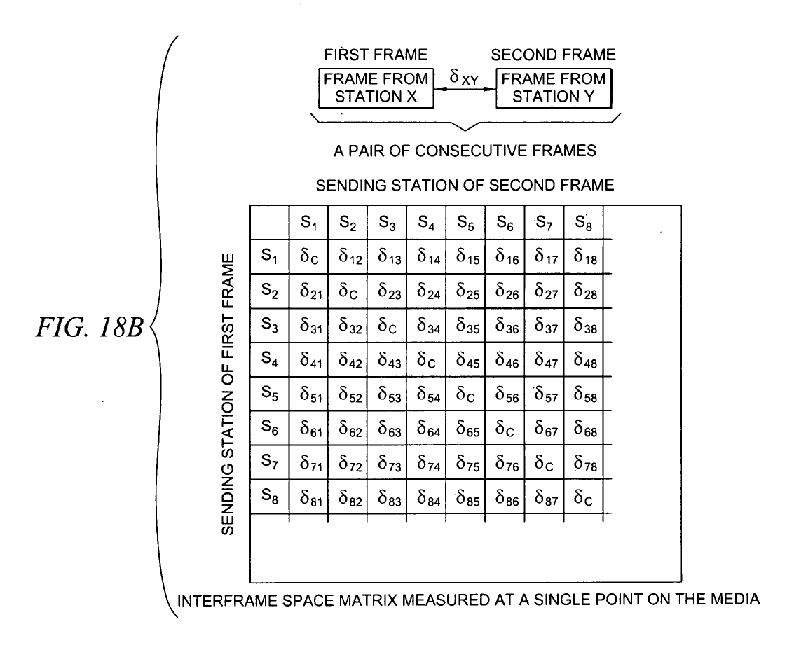

Directing attention to FIG. 18A, a logical network, with locations of various stations and a gateway (as may host point coordination of a scheduled MAC architecture of an embodiment of the present invention), is shown. An interframe space measurement algorithm is preferably located in the gateway. The algorithm preferably operates to collect information from a consecutive pair of upstream frames. For example, an interframe space measurement algorithm of embodiments operates to collect information with respect to which stations the first and second frames are from and the interframe space interval therebetween. Using this information, an interframe space matrix can be completed, as shown in FIG. 18B.

Each element in the matrix of FIG. 18B represents one interframe space based on the stations that sent the frames. The interframe space should be δ_{c}, if there is no delay. The value of each element may not be constant all the time. (e.g., the media delay time could be varied by temperature in wireline system or the multi-paths in wireless system, the station may move to different locations (in the long term), etc.). The minimum interframe space is an important value because, if it is too small, there is a potential of overlapping two adjacent frames. Accordingly, embodiments of the invention operate to keep track of the minimum interframe space. The elements of the interframe space matrix of FIG. 18B are the minimum interframe space values.

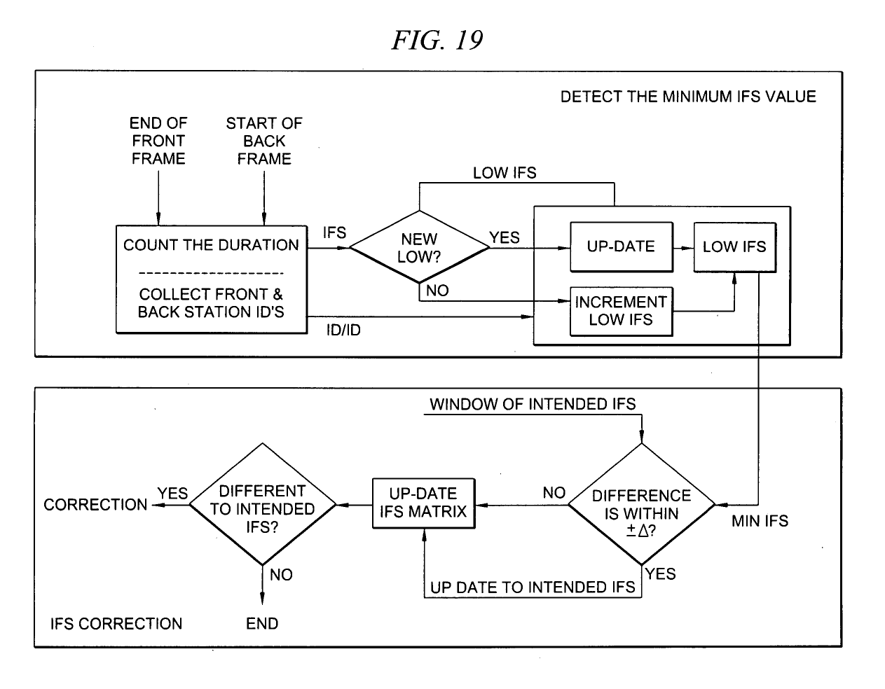

FIG. 19 shows a flow diagram of operation of an algorithm operable to keep track of the minimum interframe spaces according to an embodiment of the invention. As interframe spaces associated with particular station pairs are determined, those interframe spaces are compared with the interframe spaces stored in the interframe space matrix. If the interframe space input is less than the stored interframe space value, the stored interframe space value will be up dated to the interframe space input value. However, if the interframe space input is larger than the stored interframe space value, then the stored interframe space value would preferably be increased a fraction higher than the previous stored value. Such an embodiment not only facilitates reducing an interframe space value based upon observed network conditions, but also facilitates tracking the appropriate interframe space value if the minimum value is increased (e.g., a station is relocated, media propagation conditions change, etcetera).

If the measured minimum interframe space is larger than the desired interframe space, then a correction would be made in the information of the when to send sub-interval of embodiments by advancing the sending time of the corresponding station. This action is reversed if the measured interframe space were smaller than the desired interframe space. The goal of the foregoing interframe space correction is to make the measured minimum interframe spaces equal to the desired interframe spaces. Operation of an interframe space correction algorithm of an embodiment is shown in the interframe correction portion of the flow diagram of FIG. 19.

In operation according to preferred embodiments of the invention, new stations joining the network (or stations of a newly deployed network) will use a default interframe space value that is sufficiently large to protect the frames from overlapping. Once the station accesses the medium, the interframe space algorithm of embodiments of the invention will measure interframe spacing associated with the station and will operate to reduce the interframe space value to a desired value.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of mater, means, methods, or steps.

What is claimed is:

1. A method for providing media access control for a shared medium, said method comprising:
defining a plurality of medium access functions for defining interaction by a plurality of stations with respect to a shared medium; and
controlling access to the shared medium to perform one medium access function of said plurality of medium access functions at a time to service each station with a current need to access the shared medium in the performance of a same medium access function.

2. The method of claim 1, wherein said controlling access to the shared medium comprises:
each said station with a current need to access the shared medium conducting a request for media access using a first medium access function prior to each such station conducting data transmission using a second medium access function.

3. The method of claim 1, further comprising:
providing a scheduled media access control architecture defining a protocol for accessing shared medium, wherein said controlling access to the shared medium is in accordance with said scheduled media access control architecture.

4. The method of claim 3, wherein said protocol comprises a super frame architecture, and said plurality of medium access functions comprise a plurality of functional intervals within said super frame architecture.

5. The method of claim 4, further comprising:
adjusting an attribute of said super frame architecture to optimize a media access control performance parameter.

6. The method of claim 5, wherein said adjusting an attribute comprises:
adjusting a length of a super frame interval, wherein said performance parameter comprises throughput.

7. The method of claim 5, wherein said adjusting an attribute comprises:
adjusting traffic flow control within super frames of said super frame architecture to optimize access fairness.

8. The method of claim 5, wherein said adjusting an attribute comprises:
adjusting interframe spacing of frames within super frames of said super frame architecture to optimize throughput.

9. The method of claim 8, wherein said adjusting interframe spacing comprises:
determining information with respect to propagation delay on the shared medium.

10. The method of claim 5, wherein said adjusting an attribute comprises:
adjusting an order of functional intervals providing said plurality of medium access functions in said super frame.

11. The method of claim 1, wherein said medium access functions comprise a need for access function, wherein each said station with a current need to access the shared medium indicates a need for access using said need for access function.

12. The method of claim 11, wherein indication of a need for access using said need for access function comprises a short frame to show one of a plurality of possible states.

13. The method of claim 12, wherein said plurality of possible states are three possible states, wherein said three possible states are a need to access the shared medium, no need to access the shared medium, and idle.

14. The method of claim 11, wherein said medium access functions further comprise a request for resources function, wherein each said station with a current need to access the shared medium provides information with respect to requested resources using said request for resources function.

15. The method of claim 14, wherein said information with respect to requested resources comprises information for reserving a plurality of data frame transmissions.

16. The method of claim 14, wherein said medium access functions further comprise a request for resources schedule function providing scheduling with respect to said request for resources function, wherein a schedule of said request for resources scheduling function is determined at least in part from information provided with respect to said need for access function.

17. The method of claim 14, wherein said medium access functions further comprise a when to send function, wherein stations of said stations with a current need to access the shared medium are provided information with respect to accessing the shared medium using said when to send function.

18. The method of claim 17, wherein said information with respect to accessing the shared medium comprises a schedule for data frame transmission.

19. The method of claim 17, wherein said information with respect to accessing the shared medium comprises a size for data frame transmission.

20. The method of claim 17, wherein said medium access functions further comprise a data frame transmission function, wherein payload data with respect to said stations provided information with respect to accessing the shared medium is carried in data frames of said data frame transmission function.

21. The method of claim 20, wherein data frame transmission of said data frame transmission function is directly from a source station to a destination station.

22. The method of claim 20, wherein data frame transmission of said data frame transmission function is from a source station to a destination station through a transit point.

23. The method of claim 22, wherein said transit point comprises a gateway hosting point coordination providing said controlling access to the shared medium.

24. The method of claim 1, wherein said medium access functions comprise a request for resources function and a when to send function, wherein each said station with a current need to access the shared medium provides information with respect to requested resources using said request for resources function, and wherein stations of said stations with a current need to access the shared medium are provided information with respect to accessing the shared medium using said when to send function.

25. The method of claim 1, further comprising:
providing point coordination for implementing said controlling access to the shared medium.

26. A method for providing media access control for a shared medium, said method comprising:
defining a super frame interval having a plurality of functional intervals therein, said functional intervals for serving a plurality of stations with respect to a respective function; and
operating all stations having a current need for accessing the shared medium to perform a function associated with a particular one of said plurality of functional intervals in a current super frame before any station performs a function associated with a different one of said plurality of functional intervals in said current super frame.

27. The method of claim 26, wherein said plurality of functional intervals comprise a functional interval having time slots for each active station on the shared medium to indicate a need for accessing the shared medium.

28. The method of claim 27, wherein said plurality of functional intervals comprise a functional interval having time slots for providing information with respect to accessing the shared medium to each station having indicated a need for accessing the shared medium.

29. The method of claim 27, wherein said plurality of functional intervals comprise a functional interval having time slots for each station having indicated a need for accessing the shared medium to provide information with respect to resources requested.

30. The method of claim 26, wherein said plurality of functional intervals comprise a functional interval having time slots for each station having a need for accessing the shared medium to provide information with respect to resources requested.

31. The method of claim 26, wherein said plurality of functional intervals comprise a functional interval having time slots for each station having a need for accessing the shared medium to transmit a data frame.

32. The method of claim 26, wherein said operating al stations having a current need for accessing the shared medium comprises:
using point coordination to control said stations.

33. The method of claim 32, wherein said point coordination provides contentionless access to the shared medium by said stations.

34. The method of claim 32, wherein said point coordination is provided knowledge of traffic requirements with respect to the shared medium via one or more of said functional intervals.

35. The method of claim 32, further comprising:
said point coordination providing access fairness with respect to the shared medium through station time slot assignments in said functional intervals.

36. The method of claim 35, wherein said access fairness provides access preference to at least one station identified to said point coordination by an administrator.

37. A system comprising:
a shared medium;
a plurality of stations coupled to said shared medium; and
a point coordination host node coupled to said shared medium, wherein point coordination logic operable upon said host node controls stations of said plurality of stations, for each super frame interval, to each perform one medium access function of a plurality of medium access functions before any station performs a next medium access function of said plurality of medium access functions.

38. The system of claim 37, wherein stations of said plurality of stations comprise:
media access control logic responsive to said point coordination for use with a standardized physical layer interface of said stations.

39. The system of claim 38, wherein said standardized physical layer interface comprises an Ethernet network interface physical layer.

40. The system of claim 38, wherein said standardized physical layer interface comprises a WiFi network interface physical layer.

41. The system of claim 37, wherein stations of said plurality of stations comprise:
a protocol adaptor operable to make operation of said point control transparent to a standard network adaptor of said stations.

42. The system of claim 37, wherein said host node comprises a gateway.

43. The system of claim 37, wherein said host node comprises:
a media interface providing an interface with said shared medium; and
a multiplxer/demultiplexer function providing combining/separation of control ones of said medium access functions from data ones of said medium access functions.

44. The system of claim 37, wherein stations of said plurality of stations comprises:
a media interface providing an interface with said shared medium; and
a multiplxer/demultiplexer function providing combining/separation of control ones of said medium access functions from data ones of said medium access functions.

45. The system of claim 37, wherein said point coordination logic comprises:
a flow control algorithm for controlling which stations of said plurality of stations are provided access to said shared medium.

46. The system of claim 45, wherein said flow control algorithm further controls an amount of access to said shared medium provided to said stations.

47. The system of claim 37, wherein said point coordination logic comprises:
an interframe space adjusting algorithm for providing adjustable interframe spaces within said super frame interval.

48. The system of claim 47, wherein said interframe space is adjusted based at least in part on medium propagation information collected by said point coordination logic.

49. The system of claim 37, wherein said point coordination logic comprises:
a super frame sequence adjusting algorithm for providing adjustable sequences of said medium access intervals with respect to said super frame interval.

50. The system of claim 37, wherein said point coordination logic comprises:
a data frame reservation algorithm for facilitating reservation of a plurality of data frames with respect to a particular station of said plurality of stations.

51. The system of claim 50, wherein said plurality of data frames are in consecutive super frame intervals.

52. The system of claim 50, wherein said plurality of data frames are in non-consecutive super frame intervals.
